(19) United States
(12) Patent Application Publication
(10) Pub. No.: US 2011/0059661 A1
(43) Pub. Date: Mar. 10, 2011

(54) ELECTRICAL CONNECTOR ASSEMBLY FOR CONNECTING PRINTED CIRCUIT BOARD AND ELECTRICAL COMPONENT, AND ELECTRIC DEVICE

(75) Inventors: Noriyasu INOMATA, Toyota-shi (JP); Toshihiro MIYAKE, Inuyama-shi (JP); Yasuyuki TACHIBANA, Chiryu-shi (JP); Hideyuki IIBOSHI, Tokai-shi (JP)

(73) Assignee: DENSO CORPORATION, Kariya-city (JP)

(21) Appl. No.: 12/877,656

(22) Filed: Sep. 8, 2010

(30) Foreign Application Priority Data
Sep. 8, 2009 (JP) 2009-206995
Sep. 9, 2009 (JP) 2009-208032
Sep. 9, 2009 (JP) 2009-208177
Sep. 9, 2009 (JP) 2009-208178

(51) Int. Cl. H01R 13/33

(52) U.S. Cl. 439/841

(57) ABSTRACT

An electrical connector assembly having a connector part for electrically and mechanically connecting a printed circuit board with a land part to a lead part of an electrical component by inserting the lead part into the connector part. The connector part composed of a line spring member having a fixed end part, a terminal fixing part, and an elastic deforming part. The fixed end part is fixed to the land part. The terminal fixing part formed by winding the line spring member elastically fastens the lead part. The elastic deforming part is elastically deformed when external force is applied to the lead part while maintaining the lead part fixed to the terminal fixing part.

### CROSS-REFERENCE TO RELATED APPLICATION

This application is related to and claims priority from Japanese Patent Applications No. 2009-208032 filed on Sep. 9, 2009, No. 2009-208178 filed on Sep. 9, 2009, No. 2009-206995 filed on Sep. 8, 2009, and No. 2009-208177 filed on Sep. 9, 2009, the contents of which are hereby incorporated by reference.

### BACKGROUND OF THE INVENTION

1. Field of the Invention

The present invention relates to an electrical connector assembly having an improved structure for electrically and mechanically connecting a printed circuit board and an electrical component, and further relates to an electric device having the electrical connector assembly.

2. Description of the Related Art

There is an electrical connector assembly having a detachable structure for connecting a printed circuit board and a lead part of an electrical component. An electrical socket is fixed to a through hole formed in the printed circuit board by solder. The lead part of electrical component is inserted into the electrical socket formed in the printed circuit board so that the printed circuit board is electrically and mechanically connected to the electrical component. For example, Japanese utility model registration No. 3104494 discloses such a conventional technique.

Specifically, one end part of the electrical socket is divided into a plurality of parts in the above conventional electrical connector assembly. In particular, the separated parts of the end part of the electrical socket form an elastic holding part having a convergent front shape. Because the lead part of the electrical component has a diameter which is larger than that of the elastic holding part, the lead part is electrically and mechanically connected to the electrical socket by the elastic force of the elastic holding part when the lead part is inserted into the electrical socket of the printed circuit board, and the lead part becomes in contact with the elastic holding part of the electrical socket.

However, in the conventional electrical connector assembly for connecting the electrical component and the printed circuit board disclosed in Japanese utility model registration NO. 3104494, the lead part of the electrical component is supported only by elastic force of an elastic holding part. This structure has a possibility of sliding the lead part in the elastic supporting part when external force is caused by thermal expansion or vibration in the electrical component, and then applied to the lead part. This further increases a contact resistance between the lead part and the elastic holding part and causes abrasion due to the sliding between them.

For example, in order to avoid the above drawback of the conventional electrical connector assembly, it is possible to increase the holding force to hold the lead part of the electrical component by using the elastic supporting part having a diameter which is greatly smaller than that of the lead part of the electrical component. This structure can suppress the lead part from sliding in the elastic supporting part. However, when external force caused by thermal expansion of the electrical component is applied to the lead part in the conventional electrical connector assembly, it is possible to suppress the lead part from sliding in the elastic supporting part, but, this has a possibility of breaking the lead part or separating the solder part with which the lead part of the electrical component and the socket formed in the printed circuit board are electrically and mechanically connected together. That is, because of being hardly deformed, the lead part is broken by such external force. Further, the solder part is separated from the lead part of the electrical component and the socket part of the printed circuit board because external force is applied to the solder part through the lead part and the elastic holding part of the electrical socket.

There is another conventional technique disclosed in Japanese patent laid open publication No. JP 2001-52788. This conventional technique shows an electrical connector assembly having a structure to connect a flexible circuit substrate and a printed circuit board. In order to prevent them from coming off, the electrical connector assembly has a structure in which a plug part which serves as a male part is fitted into a contact part which serves as a female part. This structure prevents the plug part from coming off the contact part, and avoids contact failure regarding a bad electrical connection between them.

Thus, the structure of the electrical connector assembly, disclosed in Japanese patent laid open publication No. JP 2001-52788, provides a tight connection structure between the plug part and the contact part, that is, prevents that the plug part comes off the contact part. However, in this electrical connector assembly, the contact part is elastically deformed in a direction which is perpendicular to the mating direction of the plug part and the contact part. Further, the contact part has a contact curved part at which the contact part is in contact with the plug member. There is therefore a possibility of sliding the plug part on the contact curved part of the contact part along the direction to which the plug member comes off the contact part. Accordingly, it is difficult for the conventional electrical connection assembly to avoid abrasion generated by such sliding of the plug part, and this structure thereby increases the contact resistance between the plug part and the contact part.

### SUMMARY OF THE INVENTION

It is an object of the present invention to provide an electrical connector assembly for electrically and mechanically connecting an electric device and a printed circuit board in an electric device. Using the electrical connector assembly suppresses a lead part of the electrical component from sliding in a connector part formed in the printed circuit port, and thereby suppresses increasing of a contact resistance between the lead part of the electrical component and the connector part of the printed circuit board.

It is another object of the present invention to provide the electrical connector assembly which prevents a solder part which is used to electrically connect and fix the lead part of the electrical component to the connector part from being separated, and also prevents the lead part of the electrical component from breaking.

To achieve the above purposes, the present invention provides an electrical connector assembly having a connector part for electrically and mechanically connecting a lead part of an electrical component to a printed circuit board by inserting the lead part into the connector part. With the connector part, the electrical component is electrically and mechanically disconnected from the printed circuit board by detaching the lead part from the connector part.

The connector part is composed of a line spring member. The connector part has a fixed end part, a terminal fixing part, and an elastic deforming part. The fixed end part is formed at one end part of the line spring member and fixed to the land part formed in the printed circuit board. The terminal fixing part elastically fastens the lead part of the electrical component, and formed by winding the line spring member at the other end part of the line spring member which is opposite to the fixed end part in position of the line spring member. The elastic deforming part is capable of being elastically deformed and formed between the fixed end part and the terminal fixing part of the line spring member. In the electrical connector assembly according to the present invention, the electrical component is mechanically fixed to the printed circuit board and electrically connected to the printed circuit board through the connector part when the lead part of the electrical component is fixed by the terminal fixing part. The elastic deforming part is deformed by external force which is applied to the lead part while the terminal fixing part fixes the lead part.

Because the elastic deforming part is deformed by elastic deformation when external force is applied to the lead part of the electrical component, this makes it possible to suppress a contact point between the lead part and the terminal fixing part from sliding. It is thereby possible to suppress increasing of a contact resistance between the lead part and the terminal fixing part due to sliding of the contact point between the lead part and the terminal fixing part.

Further, the elastic deforming part is deformed when external force is applied to the lead part of the electrical component. This deformation absorbs (or consumes) the external force, and makes it possible to suppress the applied external force from being concentrated on the lead part. This also avoids breaking the lead part.

For example, it is possible for the electrical connector assembly to have a coil spring as the connector part. The coil spring is formed by winding the line spring member so that an inner diameter of the elastic deforming part is greater than an inner diameter of the terminal fixing part. The coil spring is formed in a longitudinal direction which is perpendicular to a surface direction of the printed circuit board.

Further, it is possible for electrical connector assembly to have a structure in which the land part is formed on a first surface of the printed circuit board. The first surface faces the electrical component side. The fixed end part has a concentric circle part placed on the first surface of the printed circuit board which faces the electrical component, and the concentric circle part is fixed to the land part formed on the first surface of the printed circuit board. The elastic deforming part is placed on the first surface of the printed circuit board on which the fixed end part having the concentric circle part is placed.

Because this structure can avoid applying the force for inserting the lead part into the terminal fixing part in the direction to separate the land part from the fixed end part, this makes it possible to suppress an electrical connection failure from being caused between the fixed end part and the land part.

It is further possible for the electrical connector assembly to have a structure in which a through hole is formed in the printed circuit board so that the through hole penetrates in a thickness direction of the printed circuit board. The land part is formed on a first surface of the printed circuit board which faces the electrical component and around the through hole. The fixed end part is wound in a concentric circle on the first surface of the printed circuit board, and the fixed end part has a concentric circle part. The outermost diameter of the concentric circle part is greater than an inner diameter of the through hole, and the concentric circle part is fixed onto the land part formed on the first surface of the printed circuit board. The elastic deforming part projects through the through hole and into a second surface of the printed circuit board which is opposite to the first surface of the printed circuit board.

In addition, it is further possible to have a structure in which a through hole is formed in the printed circuit board so that the through hole penetrates in a thickness direction of the printed circuit board. A land part is also formed on a second surface, around the through hole, which is opposite to a first surface of the printed circuit board which faces the electrical component. The fixed end part is wound in a concentric circle on the second surface of the printed circuit board, and the fixed end part has a concentric circle part, and the outermost diameter of the concentric circle part is greater than an inner diameter of the through hole, and the concentric circle part is fixed onto the land part formed on the second surface of the printed circuit board. The elastic deforming part projects on the second surface side of the printed circuit board through the through hole.

In the above structure of the electrical connector assembly according to the present invention, because the fixed end part is fixed to the land part under the state where a part of the elastic deforming part is placed in the inside of the through hole, it is possible to suppress the connector part from sliding toward the surface direction of the printed circuit board by the inner wall surface, and this structure makes it possible to achieve easy work to assemble the printed circuit board and the electrical component by using the connector part.

Still further, it is further possible to have a structure in which a through hole is formed in the printed circuit board so that the through hole penetrates in a thickness direction of the printed circuit board. The land part is formed on a second surface, around the through hole, which is opposite to a first surface of the printed circuit board which faces the electrical component. The fixed end part is wound in a concentric circle on the second surface of the printed circuit board, and the fixed end part has a concentric circle part, and the outermost diameter of the concentric circle part is greater than an inner diameter of the through hole, and the concentric circle part is fixed onto the land part formed on the second surface of the printed circuit board. The elastic deforming part is placed at the second surface side of the printed circuit board which is opposite to the first surface of the printed circuit board.

Still further, it is possible for the electrical connector assembly to have a structure in which the fixed end part has the concentric circle part and a vertical part of a compressed shape which is composed of the line spring member spirally wound in a direction perpendicular to the surface direction of the printed circuit board, and the fixed end part is fixed onto the land part by solder with which the outer peripheral surface of the vertical part and the concentric circle part are covered to form a solder fillet.

In the above structure of the electrical connector assembly, because the solder fillet is formed so that the outer peripheral surface of the vertical part and the concentric circle part are covered with solder, this structure makes it possible to provide the improved electrical connection between the fixed end part and the land part.

Still further, it is possible for the electrical connector assembly to have a structure in which a through hole is formed in the printed circuit board so that the through hole penetrates in a thickness direction of the printed circuit board, the land part is formed on an inner wall surface of the through hole, and the fixed end part is press-inserted into the through hole to fix it to the land part formed on the inner wall surface of the through hole with press-insertion.

The electrical connector assembly having each of the above structures can be applied to various types of electric devices, for example, an electric device having a case, an electronic component, and a printed circuit board. The case has a bottom surface and a side wall which is formed in a direction which is perpendicular to the bottom surface. The electrical component fixed onto the bottom surface of the case. The printed circuit board fixed to the side wall of the case. The electrical connector assembly has a connector part for electrically and mechanically connecting the lead part of the electrical component to the printed circuit board with the land part by inserting the lead part into the connector part in the direction which is perpendicular to the surface direction of the printed circuit board.

### BRIEF DESCRIPTION OF THE DRAWINGS

A preferred, non-limiting embodiment of the present invention will be described by way of example with reference to the accompanying drawings, in which:

FIG. 1 is a view showing a cross section of an electric device having an electrical connector assembly according to a first embodiment of the present invention, with which a printed circuit board and an electrical component are electrically and mechanically connected;

FIG. 2 is an enlarged view of the electrical connector assembly indicated by a long dashed and double dotted line shown in FIG. 1;

FIG. 3 is a perspective view showing a coil spring in the electrical connector assembly shown in FIG. 2;

FIG. 4 is a view showing a cross section along the A-A long and dotted line shown in FIG. 2;

FIG. 5 is a view showing a partial enlarged part of an electric device having an electrical connector assembly according to a second embodiment of the present invention, with which a printed circuit board and an electrical component are electrically and mechanically connected;

FIG. 6 is a view showing a partial enlarged part of an electric device having an electrical connector assembly according to a third embodiment of the present invention, with which a printed circuit board and an electrical component are electrically and mechanically connected;

FIG. 7 is a view showing a partial enlarged part of an electric device having an electrical connector assembly according to a fourth embodiment of the present invention, with which a printed circuit board and an electrical component are electrically and mechanically connected;

FIG. 8 is a view showing a partial enlarged part of an electric device having an electrical connector assembly according to a fifth embodiment of the present invention, with which a printed circuit board and an electrical component are electrically and mechanically connected;

FIG. 9 is a view showing a partial enlarged part of an electric device having an electrical connector assembly according to a sixth embodiment of the present invention, with which a printed circuit board and an electrical component are electrically and mechanically connected;

FIG. 10 is a view showing a partial enlarged part of an electric device having an electrical connector assembly according to a seventh embodiment of the present invention, with which a printed circuit board and an electrical component are electrically and mechanically connected;

FIG. 11 is a view showing a cross section of an electric device having an electrical connector assembly according to another modification of the present invention, with which a printed circuit board and an electrical component are electrically and mechanically connected;

FIG. 12 is a view showing a cross section of an electric device having an electrical connector assembly according to an eighth embodiment of the present invention, with which a printed circuit board and an electrical component are electrically and mechanically connected;

FIG. 13A is an enlarged view of the electrical connector assembly indicated by a long dashed and double dotted line shown in FIG. 12;

FIG. 13B is an enlarged view of the electrical connector assembly of the printed circuit board and the electrical component observed from a direction which is perpendicular to the direction shown in FIG. 12;

FIG. 13C is a view of the electrical connector assembly of the printed circuit board and the electrical component observed from a top shown in FIG. 12;

FIG. 14 is a view showing a cross section of an electric device having an electrical connector assembly according to a ninth embodiment of the present invention, with which a printed circuit board and an electrical component are electrically and mechanically connected;

FIG. 15A is an enlarged view of the electrical connector assembly indicated by a long dashed and double dotted line shown in FIG. 14;

FIG. 15B is an enlarged view of the electrical connector assembly of the printed circuit board and the electrical component observed from a direction which is perpendicular to the direction shown in FIG. 14;

FIG. 16 is a view showing an electrical connector assembly according to a tenth embodiment of the present invention, with which a printed circuit board of an electric device and an electrical component are electrically and mechanically connected;

FIG. 17A is a front view of a connector part of the electrical connector assembly according to another modification of the present invention;

FIG. 17B is a bottom view of the connector part of the electrical connector assembly shown in FIG. 17A;

FIG. 17C is a right side view of the connector part of the electrical connector assembly shown in FIG. 17A;

FIG. 18A is a front view of a connector part of the electrical connector assembly according to another modification of the present invention;

FIG. 18B is a bottom view of the connector part of the electrical connector assembly shown in FIG. 18A;

FIG. 18C is a right side view of the connector part of the electrical connector assembly shown in FIG. 18A;

FIG. 19 is a view showing a cross section of an electric device having an electrical connector assembly according to an eleventh embodiment of the present invention, with which a printed circuit board and an electrical component are electrically and mechanically connected;

FIG. 20 is an enlarged view of the electrical connector assembly indicated by a long dashed and double dotted line shown in FIG. 19;

FIG. 21 is a view showing a partial enlarged part of an electric device having an electrical connector assembly according to a twelfth embodiment of the present invention, with which a printed circuit board and an electrical component are electrically and mechanically connected;

FIG. 22 is a view showing a partial enlarged part of an electric device having an electrical connector assembly according to a thirteenth embodiment of the present invention, with which a printed circuit board and an electrical component are electrically and mechanically connected;

FIG. 23 is a view showing a partial enlarged part of an electric device having an electrical connector assembly according to a modification of the present invention, with which a printed circuit board and an electrical component are electrically and mechanically connected;

FIG. 24 is a view showing a cross section of an electric device having an electrical connector assembly according to a fourteenth embodiment of the present invention, with which a printed circuit board and an electrical component are electrically and mechanically connected;

FIG. 25 is an enlarged view of the electrical connector assembly indicated by a long dashed and double dotted line shown in FIG. 24;

FIG. 26 is an exploded perspective view of a lead part and a connector part which are taken out from a through hole formed in the printed circuit board in the electrical connector assembly shown in FIG. 24;

FIG. 27 is a perspective view of the electrical connector assembly shown in FIG. 24 in which the lead part and the connector part are inserted in the through hole;

FIG. 28 is view showing a perspective cross section of the electrical connector assembly in which the lead part is inserted and fitted into the connector part under a state in which a locking part in the connector part is fitted into the through hole in the electrical connector assembly shown in FIG. 24;

FIG. 29A, FIG. 29B, and FIG. 29C are enlarged views of the lead part and the connector part when the lead part is fitted into and detached from the connector part in the electrical connector assembly shown in FIG. 24; and

FIG. 30 is a perspective view showing the electrical connector assembly in the electric device shown in FIG. 24 according to the fourteenth embodiment of the present invention, in which the lead part and the connector part are fitted into the through hole.

### DETAILED DESCRIPTION OF THE PREFERRED EMBODIMENTS

Hereinafter, various embodiments of the present invention will be described with reference to the accompanying drawings. In the following description of the various embodiments, like reference characters or numerals designate like or equivalent component parts throughout the several diagrams.

### First Embodiment

A description will be given of an electrical connector assembly according to a first embodiment of the present invention.

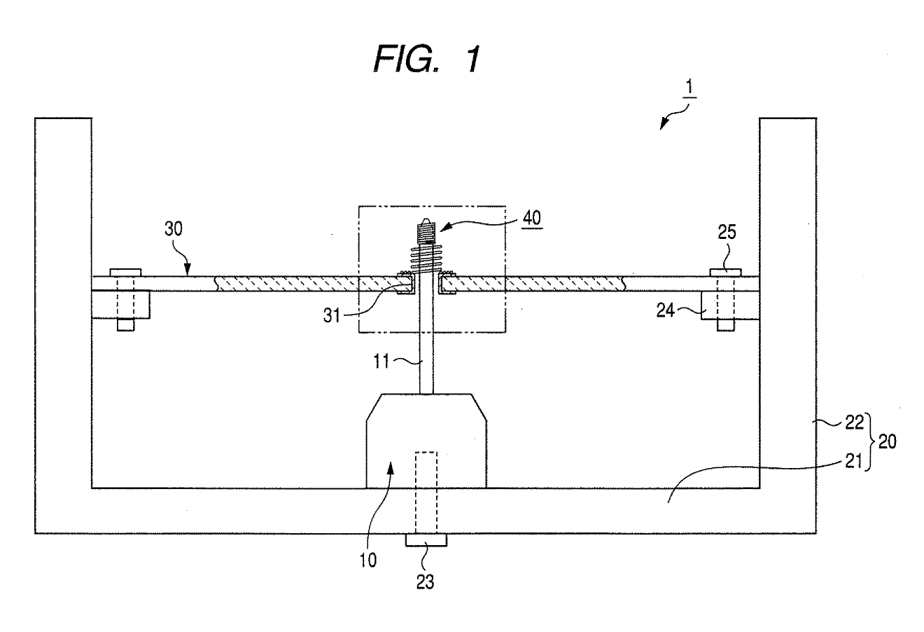

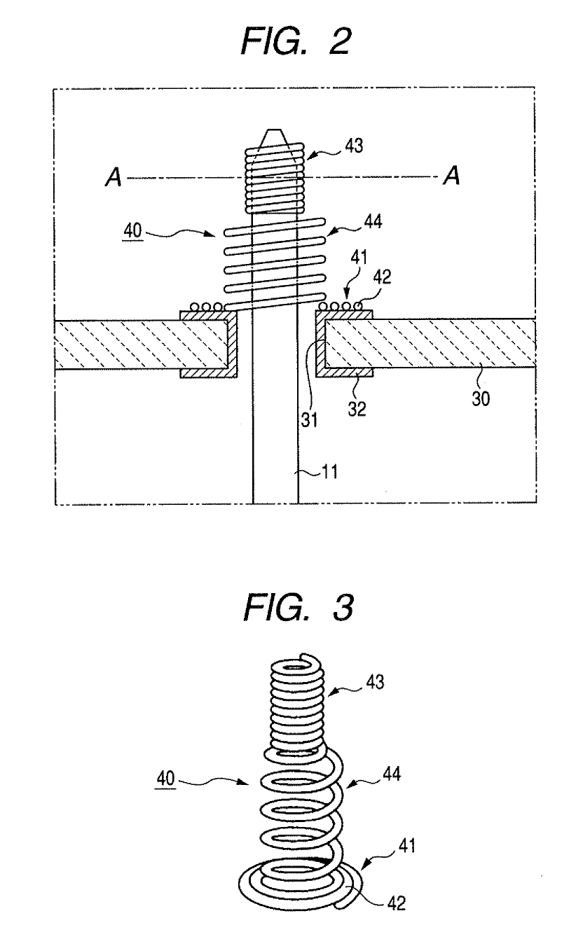

FIG. 1 is a view showing a cross section of an electric device 1 having the electrical connector assembly according to the first embodiment of the present invention. In the electric device 1 shown in FIG. 1, a printed circuit board 30 and an electrical component 10 are electrically and mechanically connected together through the electrical connector assembly. FIG. 2 is an enlarged view of the electrical connector assembly which is designated by a long dashed and double dotted line shown in FIG. 1.

As shown in FIG. 1, the electric device 1 is composed of the electrical component 10, a case 20, the printed circuit board 30, and a coil spring 40. The coil spring 40 serves as the connector part of the electrical connector assembly according to the first embodiment.

The case 20 has a side wall surface part 22 and a bottom surface part 21. The electrical component 10 is placed on the bottom surface part 21 of the case 20. The electrical component 10 is fixed onto the bottom surface part 21 of the case 20 by a screw part 23. The electrical component 10 has a plurality of lead parts 11. Each of the lead parts 11 is inserted into the coil spring 40 in the vertical direction which is perpendicular to the surface direction of the printed circuit board 30. This inserting makes it possible to electrically and mechanically connect the electrical component 10 to the printed circuit board 30 through the coil spring 40.

Specifically, as shown in FIG. 2, each of the lead parts 11 of the electrical component 10 has a front tip part of a convergent shape. A cross section of the lead part 11 in the direction which is perpendicular to the inserting direction has a square shape. Each of the lead parts 11 is fixed to the printed circuit board 30 by the coil spring 40, and the electrical component 10 electrically and mechanically contacts with the coil spring 40. The electrical component 10 is a through hole device (THD), etc., for example.

The bottom surface part 21 of the case 20 has a rectangle shape. A side wall surface part 22 stands, that is, is placed in the vertical direction at both sides of the bottom surface part 21. A supporting part 24 is formed at the inside wall surface of the side wall surface part 22. The printed circuit board 30 is mounted on the supporting parts 24 of the case 20 by screw parts 25. As shown in FIG. 2, each of the screw parts 25 screws the printed circuit board 30 onto the supporting parts 24 of the case 20 by inserting it from the main surface side of the printed circuit board 30 to the supporting parts 24. The printed circuit board 30 is thereby fixed to the case 20. In the first embodiment shown in FIG. 1 and FIG. 2, the electrical component 10 faces a front surface (or a first surface) of the printed circuit board 30, and the coil spring 40 is placed at a back surface (or a second surface) side of the printed circuit board 30.

The printed circuit board 30 is a circuit board which is composed mainly of a printed wiring substrate, on which circuit components and wiring are mounted. A plurality of through holes 31 is formed in the printed circuit board 30, to which the corresponding lead part 11 is inserted.

Land parts 32 are formed around the through holes 31 on both the front surface (first surface) and the back surface (second surface) of the printed circuit board 30, and further formed on the inside wall surface of the through holes 31.

In the first embodiment, the through hole 31 has a circular cross section, and formed for each of the lead parts 11. That is, the total number of the through holes 31 is the equal to that of the lead parts 11. The land part 32 is provided formed for each of the through holes 32. The land part 32 is further formed on the inside wall surface of the trough hole 31 having a circular cross section and the peripheral area around the through hole 31 on the front surface and the back surface of the printed circuit board 30. The land part 32 is electrically connected to a corresponding circuit wiring formed on the printed circuit board 30.

The coil spring 40 is electrically connected to the land part 32, and thereby electrically connected to the circuit wiring formed on the printed circuit board 30. The total number of the coil springs 40 is equal to that of the lead parts 11. Each of the lead parts 11 is inserted into the corresponding coil spring 40 in order to electrically and mechanically connected to the corresponding coil spring 40. The coil spring 40 has a detachable structure from the lead part 11. The lead part 11 is inserted into the terminal fixing part 43 of the coil spring 40, so that the lead part 11 is electrically and mechanically connected with the coil spring 40. On the other hand, the lead part 11 and the coil spring 40 are released from the electrical and mechanical connection by detaching the lead part 11 from the coil spring 40.

Next, a description will now be given of the coil spring 40 which works as the connector part in the electrical connector assembly according to the first embodiment of the present invention.

FIG. 3 is a perspective view showing the coil spring 40 in the electrical connector assembly shown in FIG. 2. As shown in FIG. 2 and FIG. 3, the coil spring 40 is composed of a line spring member having a spiral and conical shape. That is, the coil spring 40 is made by spirally winding the line spring member. The longitudinal direction of the coil spring 40 is perpendicular to the surface direction of the printed circuit board 30. For example, the coil spring 40 is made of stainless steel plated with copper (Cu), and further plated with gold (Au).

The coil spring 40 has a fixed end part 41 with which the coil spring 40 is fixed onto the printed circuit board 30 through the land part.

Specifically, the fixed end part 41 has a concentric circle part 42 which is wound and fixed onto the surface of the printed circuit board 30. That is, the concentric circle part 42 is fixed to the land part 32 in the peripheral part around the through hole 31 formed on the back surface of the printed circuit board 30 by solder (not shown). As shown in FIG. 3, the diameter of the outermost peripheral part of the helical parts which form the concentric circle part 42 in the coil spring 40 is larger than the diameter of the through hole 31.

The coil spring 40 is composed of an end part (spiral part) which is opposite to the fixed end part 41. The coil spring 40 has a terminal fixing part 43 with which the lead part 11 is elastically fixed.

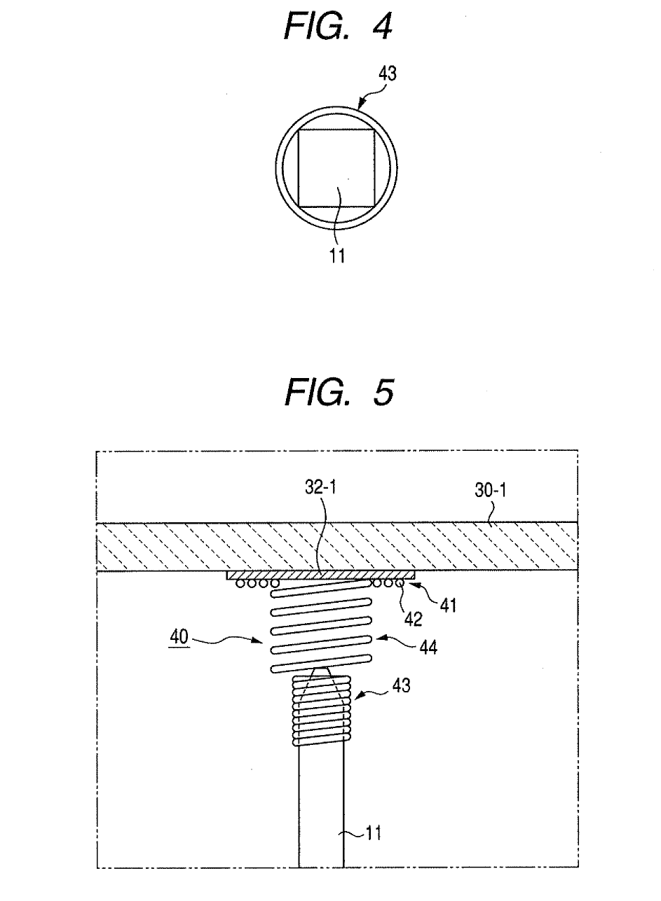

FIG. 4 is a view showing a cross section along the A-A long and dotted line shown in FIG. 2. As shown in FIG. 4, because the lead part 11 has a square cross section, the terminal fixing part 43 has an inner diameter which is smaller than a diagonal line of a cross section of the lead part 11, which is perpendicular to the inserting direction to insert the lead part 11 to the coil spring 40. When the lead part 11 is inserted with pressure, the front end part of the lead part 11 is fixed at four contact point of the terminal fixing part 43 of the coil spring 40 shown in FIG. 4. Further, as shown in FIG. 2 and FIG. 3, the terminal fixing part 43 has a compressed shape where the adjacent helical parts are compressed and close to each other.

Further, as shown in FIG. 2 and FIG. 3, the coil spring 40 is composed of a part having an elastic deforming part 44 formed between the terminal fixing part 43 and the fixed end part 41.

The elastic deforming part 44 is composed of a space winding part where the line spring member is wound with a predetermined pitch space. The elastic deforming part 44 having the above structure can be deformed in the surface direction of the printed circuit board 30 and in the direction which is perpendicular to the surface direction of the printed circuit board 30. The elastic deforming part 44 has an inner diameter which is larger than the diameter of the terminal fixing part 43. Specifically, when the lead part 11 is inserted through the elastic deforming part 44, and then fixed to the terminal fixing part 43, the elastic deforming part 44 does not contacts with the lead part 11 of the electrical component 10.

The inner diameter of the terminal fixing part 43 and the turn number of the elastic deforming part 44 of the coil spring 40 are determined so that the elastic force to tightly fix the terminal fixing part 43 to the lead part 11 becomes larger than the elastic force generated in the elastic deforming part 44 when the lead part 11 of the electrical component 10 is inserted into the terminal fixing part 43. That is, when the lead part 11 is inserted into the terminal fixing part 43 by external force, the terminal fixing part 43 is elastically deformed accompanying with the deformation of the elastic deforming part 44.

As shown in FIG. 2, the lead part 11 of the electrical component 10 is inserted into the terminal fixing part 43 of the coil spring 40 through the through hole 31 and the elastic deforming part 44 in the direction which is perpendicular to the surface direction of the printed circuit board 30. The lead part 11 of the coil spring 40 is thereby elastically and tightly fixed to the terminal fixing part 43. That is, the electrical component 10 is fixed to the printed circuit board 30 by inserting the lead part 11 into the terminal fixing part 43 of the coil spring 40. This makes it possible to electrically connect the electrical component 10 to the printed circuit board 30 through the coil spring 40, where the coil spring 40 serves as the connector part in the electrical connector assembly according to the first embodiment.

A description will now be given of the mounting and detaching operation of the lead part 11 of the electrical component 10 to and from the coil spring 40 as the connector part in the electrical connector assembly for connecting the electrical component 10 to the printed circuit board 30.

In order to electrically connect the electrical component 10 to the printed circuit board 30, it is sufficient to insert the lead part 11 of the electrical component 10 into the terminal fixing part 43 of the coil spring 40 in the direction from the surface side of the printed circuit board 30 through the through hole 31 and the elastic deforming part 44. For example, the terminal fixing part 43 of the coil spring 40 is fixed by a jig (omitted from drawings) as a fixing tool. The lead part 11 is inserted and pressed into the terminal fixing part 43 so that the terminal fixing part 43 does not deform toward the inserting direction to insert the lead part 11 of the electrical component 10 into the spring part 40.

As shown in FIG. 4, because the terminal fixing part 43 of the coil spring 40 has the inner diameter which is smaller in length than the diagonal line of the cross section of the lead part 11 in the direction which is perpendicular to the inserting direction to insert the lead part 11 to the coil spring 40, the front part of the lead part 11 is elastically fixed to the terminal fixing part 43 when the lead part 11 is pressed into the terminal fixing part 43. This makes it possible to electrically and mechanically connect the electrical component 10 to the printed circuit board 30.

In addition, when the lead part 11 of the electrical component 10 is detached from the printed circuit board 30, the terminal fixing part 43 is fixed onto a jig (not shown), and the lead part 11 is then detached from the terminal fixing part 43 so that the terminal fixing part 43 is not deformed toward the direction to detach the lead part 11 from the terminal fixing part 43. This makes it possible to electrically and mechanically detach the lead part 11 from the terminal fixing part 43.

As previously described in detail, in the electric device 1 having the electrical connector assembly with the coil spring 40 according to the first embodiment of the present invention, because the elastic deforming part 44 in the coil spring 40 is elastically deformed, it is possible to suppress the contact point between the lead part 11 and the terminal fixing part 43 from sliding. This makes it possible to suppress increasing of the contact resistance at the contact point between the lead part 11 of the electrical component 10 and the terminal fixing part 43 of the coil spring 40.

In addition, when external force is applied to the lead part 11, the elastic deforming part 44 can be deformed in order to absorb (or spread) the applied external force. This makes it possible to prevent the applied external force from remaining in the lead part 11 of the electrical component 10, and to avoid breaking the lead part 11 of the electrical component 10. Further, it is possible to suppress the transmission of the applied external force to the solder part by which the fixed end part 41 is electrically fixed to the land part 32 of the printed circuit board 30. This can avoid separating the solder part from fixed end part 41 and the land part 32.

Still further, when external force is applied to the lead part 11 of the electrical component 10, the applied external force is transmitted to the fixed end part 41 through the elastic deforming part 44. However, because the electric device 1 is equipped with the electrical connector assembly according to the first embodiment where the inner diameter of the elastic deforming part 44 is larger than that of the terminal fixing part 43, it is possible for the electrical connector assembly according to the first embodiment to have a twisting moment which is smaller than that of a case where the elastic deforming part 44 and the terminal fixing part 43 have the same inner diameter. It is thereby possible to avoid separating the solder part from fixed end part 41 and the land part 32.

Still further, because the terminal fixing part 43 is wound and compressed, namely, becomes a solid spring, it is possible to decrease the total length of the conductive path of the coil spring 40, and to decrease inductance of the coil spring 40 when compared with a case where the terminal fixing part 43 is not compressed.

### Second Embodiment

A description will now be given of the electrical connector assembly according to a second embodiment of the present invention with reference to FIG. 5. In the electrical connector assembly used in the electric device 1 according to the second embodiment, the fixed end part 41 is fixed onto the surface (first surface) of the printed circuit board 30-1. Because other components of the electrical connector assembly according to the second embodiment have the same structure of those in the electrical connector assembly according to the first embodiment, the following description will be given of the different components.

FIG. 5 is a view showing a partial enlarged part of the electric device having the electrical connector assembly according to the second embodiment of the present invention. The printed circuit board 30-1 and the electrical component 10 (omitted from FIG. 5) are electrically and mechanically connected together by the electrical connector assembly composed mainly of the connector part 40 and the lead part 11 of the electrical component 10. FIG. 5 shows the partial view of the electrical connector assembly according to the second embodiment, which corresponds to the part of the diagram which is designated by the long dashed and double dotted line shown in FIG. 1.

As shown in FIG. 5, in the electrical connector assembly used in the electric device 1 according to the second embodiment, no through hole is formed in the printed circuit board 30-1, and a land part 32-1 is formed on the front surface (first surface) of the printed circuit board 30-1, and not formed on the back surface of the printed circuit board 30-1. The fixed end part 41 is fixed onto the land part 32-1 by solder (not shown). The elastic deforming part 44 is placed at the surface side (first surface side) of the printed circuit board 30-1. Further, the lead part 11 is fixed to the terminal fixing part 43 without passing through the inside of the elastic deforming part 44.

In the structure of the electrical connector assembly according to the second embodiment shown in FIG. 5, the external force to insert the lead part 11 of the electrical component 10 into the terminal fixing part 43 of the coil spring 40 is not applied into the direction to separate the fixed end part 41 from the land part 32-1. This structure of the electrical connector assembly makes it possible to suppress the connection failure between the fixed end part 41 and the land part 32-1, namely, to suppress the separation of the solder part (not shown) from the fixed end part 41 of the coil spring 40 and the land part 324 formed on the printed circuit board 30-1.

Further, because the lead part 11 of the electrical component 10 is inserted into the terminal fixing part 43 on the surface side (first surface side) of the printed circuit board 30-1 without passing it through any through hole, the electrical connector assembly according to the second embodiment does not require the step of forming a through hole, and avoids the manufacturing cost to form the through hole. The total manufacturing cost to produce the electric device 1 having the electrical connection assembly can be therefore decreased.

### Third Embodiment

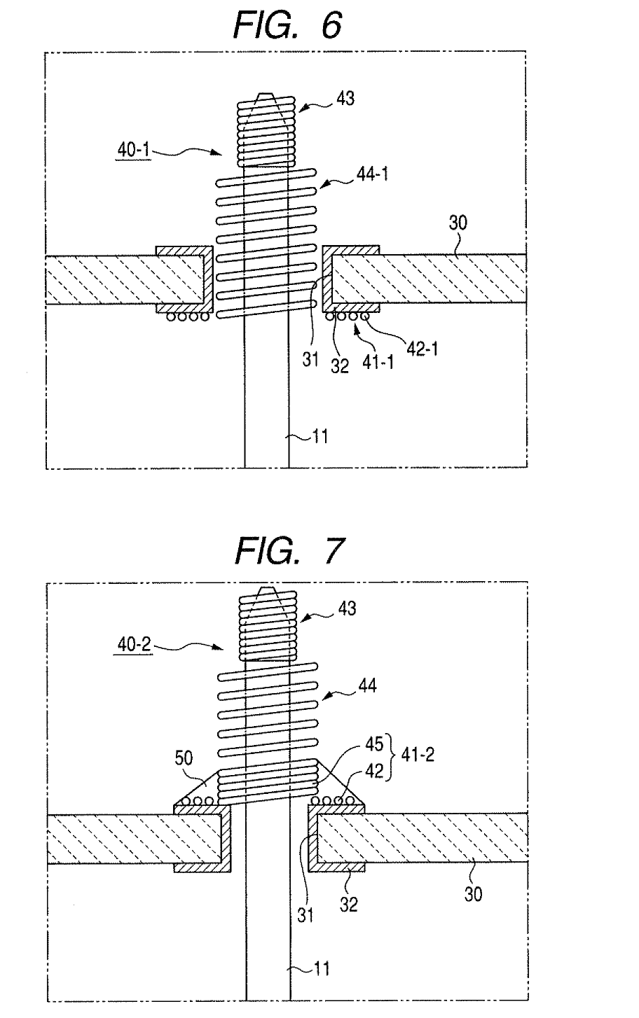

A description will now be given of the electrical connector assembly according to a third embodiment of the present invention with reference to FIG. 6. In the electrical connector assembly used in the electric device 1 according to the third embodiment, the fixed end part 41-1 is fixed onto the front surface (first surface) of the printed circuit board 30.

Because other components of the electrical connector assembly according to the third embodiment have the same structure of those in the electrical connector assembly according to the first embodiment, the following description will be given of the different components.

FIG. 6 is a view showing a partial enlarged part of the electric device 1 having the electrical connector assembly according to the third embodiment of the present invention. The electrical connector assembly electrically and mechanically connects the printed circuit board 30 and the electrical component 10 (omitted from FIG. 6). The view shown in FIG. 6 corresponds to the part designated by the dash and double dotted line shown in FIG. 1.

In the electric device 1 having the electrical connector assembly according to the third embodiment shown in FIG. 6, the fixed end part 41-1 is fixed onto the land part 32 which is formed on the front surface (first surface) of the printed circuit board 30 by solder (omitted from FIG. 6) formed around the peripheral part of the through hole 31. In particular, the elastic deforming part 44-1 is inserted into the through hole 31, and placed at the back surface side (second surface) of the printed circuit board 30. Because this structure fixes the fixed end part 41-1 to the land part 32 and a part of the elastic deforming part 44-1 is placed in the inside of the through hole 31, the remaining part of the elastic deforming part 44-1 is exposed to outside of the through hole 31. Accordingly, the inner wall surface of the through hole 31 can suppress the coil spring 40-1 from sliding toward the direction along the surface of the printed circuit board 30, and it is thereby possible to increase the stability of the assemble structure of the coil spring 40-1 and the printed circuit board 30. In the structure of the electrical connector assembly used in the electric device 1 according to the third embodiment shown in FIG. 6, the part in the elastic deforming part 44-1 of the coil spring 40-1 which is exposed to the outside of the through hole 21, namely, placed over the back surface (second surface) of the printed circuit board 30, works as an elastically deformable part which is deformed toward the direction along the back surface (second surface) of the printed circuit board 30.

### Fourth Embodiment

A description will now be given of the electrical connector assembly according to a fourth embodiment of the present invention with reference to FIG. 7. The electrical connector assembly used in the electric device 1 according to the fourth embodiment has the improved fixed end part 41-2 in the coil spring 40-2. Because other components of the electrical connector assembly according to the fourth embodiment have the same structure of those in the electrical connector assembly according to the first embodiment, the following description will be given of the different components.

FIG. 7 is a view showing a partial enlarged part of the electric device having the electrical connector assembly according to the fourth embodiment of the present invention. The printed circuit board 30 and the electrical component 10 (omitted from FIG. 7) are electrically and mechanically connected together by the electrical connector assembly according to the fourth embodiment shown in FIG. 7. The view shown in FIG. 7 corresponds to the part designated by the dash and double dotted line shown in FIG. 1.

As shown in FIG. 7, the fixed end part 41-2 is composed of the concentric circle part 42 and a vertical part 45. The vertical part 45 has a compressed shape of the helical parts which are composed of the line spring member which is spirally and closely wound.

The fixed end part 41-2 is fixed to the land part 32 by solder 50. In other words, the outer peripheral part of the vertical part 45 and the concentric circle part 42 are covered with the solder to a solder fillet. This structure of the coil spring 40-2 increases the electric and mechanical connection between the fixed end part 41-2 and the land part 32.

### Fifth Embodiment

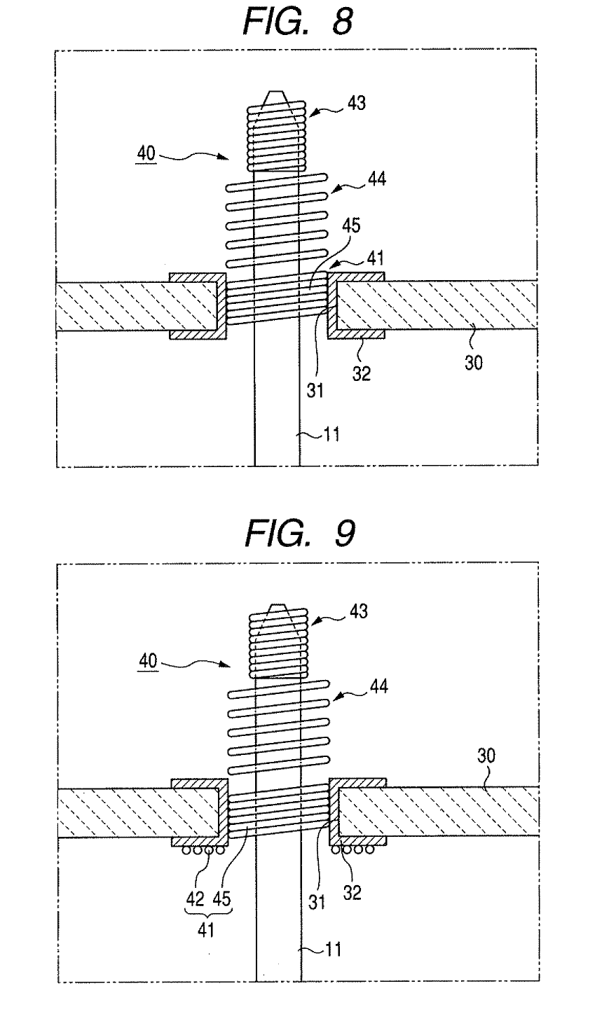

A description will now be given of the electrical connector assembly according to a fifth embodiment of the present invention with reference to FIG. 8.

In the electrical connector assembly used in the electric device 1 according to the fifth embodiment, the fixed end part 41-3 is placed in the inside of the through hole 31. Because other components of the electrical connector assembly according to the fifth embodiment have the same structure of those in the electrical connector assembly according to the first embodiment, the following description will be given of the different components.

FIG. 8 is a view showing a partial enlarged part of the electric device having the electrical connector assembly according to the fifth embodiment of the present invention. Through the electrical connector assembly according to the fifth embodiment, the electrical component 10 (omitted from FIG. 8) is electrically and mechanically connected to the printed circuit board 30. FIG. 8 shows the part corresponds to the part designated by the dash and double dotted line shown in FIG. 1.

As shown in FIG. 8, the fixed end part 41-3 is composed of the line spring member which is wound in the direction which is perpendicular to the surface direction of the printed circuit board 30. Further, the fixed end part 41-3 has the vertical part 45-1 of a compressed shape of the helical parts which are spirally and closely wound. In particular, the outer diameter of the vertical part 45-1 is larger than the inner diameter of the through hole 31.

The fixed end part 41-3 is fixed to the land part 32 which is formed on the inner wall surface of the through hole 31 by pressing and inserting the vertical part 45-1 into the inside of the through hole 31. The electric device 1 having the electrical connector assembly according to the fifth embodiment shown in FIG. 8 has the same effects of that of the first embodiment shown in FIG. 1 to FIG. 4. In addition, the structure of the electrical connector assembly according to the fifth embodiment shown in FIG. 8 makes it possible to decrease the total number of components because no solder is formed between the fixed end part 41-3 and the land part 32.

### Sixth Embodiment

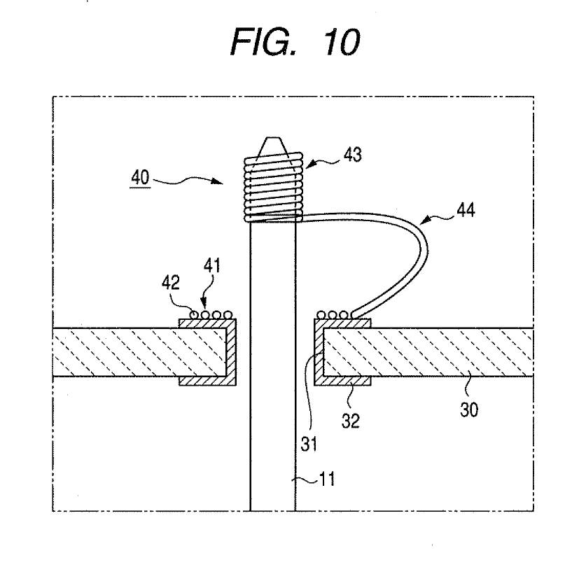

A description will now be given of the electrical connector assembly according to the six embodiment of the present invention with reference to FIG. 9.

In the electrical connector assembly used in the electric device 1 according to the sixth embodiment, the fixed end part 41-4 is fixed onto the land part 32 formed on the front surface (first surface) of the printed circuit board 30. Because other components of the electrical connector assembly according to the sixth embodiment have the same structure of those in the electrical connector assembly according to the third embodiment, the following description will be given of the different components.

FIG. 9 is a view showing a partial enlarged part of the electric device having the electrical connector assembly according to the sixth embodiment of the present invention. The printed circuit board 30 and the electrical component 10 (omitted from FIG. 9) are electrically and mechanically connected together by the electrical connector assembly. The view shown in FIG. 9 corresponds to the part designated by the dash and double dotted line shown in FIG. 1.

As shown in FIG. 9, the fixed end part 41-4 in the coil spring 44-1 has the vertical part 45-1. The vertical part 45-1 has a compressed shape of the helical parts. The helical parts are composed of line spring member which is spirally and closely wound in the direction which is perpendicular to the plane surface of the printed circuit board 30.

The concentric circle part 42-1 in the fixed end part 41-4 is fixed at the peripheral part of the through hole 31 onto the front surface of the printed circuit board 30 by solder (omitted from FIG. 9). The fixed end part 41-4 of the coil spring 40-4 is pressed and inserted into the through hole 31 and fixed and supported by the land part 32 which is formed on the inner wall surface of the through hole 31.

In the electrical connector assembly according to the six embodiment used in the electric device 1 shown in FIG. 9, the concentric circle part 42-1 in the fixed end part 41-4 of the coil spring 40-4 is fixed onto the land part 32 by solder, and the vertical part 45-1 is supported by and fixed to the land part 32 formed on the inner wall surface of the through hole 31. This makes it possible to obtain the same effects of the first embodiment, and to further improve the electric and mechanical connection between the fixed end part 41-4 and the land part 32.

### Seventh Embodiment

A description will now be given of the electrical connector assembly according to the seventh embodiment of the present invention with reference to FIG. 10.

The electrical connector assembly according to the seventh embodiment has the improved connection part 40-5 which is different in structure from the connection part (as the coil spring) in the electrical connector assembly according to the first embodiment. Because other components of the electrical connector assembly according to the seventh embodiment have the same structure of those in the electrical connector assembly according to the first embodiment, the following description will be given of the different component.

FIG. 10 is a view showing a partial enlarged part of the electric device 1 having the electrical connector assembly according to the seventh embodiment of the present invention. The printed circuit board 30 and the electrical component 10 (omitted from FIG. 10) are electrically and mechanically connected together by the electrical connector assembly. The view shown in FIG. 10 corresponds to the part designated by the dash and double dotted line shown in FIG. 1.

As shown in FIG. 10, in the electric device 1 having the electrical connector assembly according to the seventh embodiment, the connector part 40-5 is composed of the elastic deforming part 44-2 of a circular arc shape instead of using the elastic deforming part 44 having the space winding part in the coil spring 40 where the line spring member is wound with a predetermined pitch space. That is, the connector part 40-5 is not the coil spring (which works as the connector part) used in the electrical connector assembly according to the first embodiment shown in FIG. 2 and FIG. 3.

The structure of the connector part 40-5 in the electrical connector assembly according to the seventh embodiment has the same effects of the first embodiment and can achieve a flexible design work because of not using the coil spring.

When external force is applied to the lead part 11 of the electrical component 10, the elastic deforming part 44-2 having a circular arc shape is deformed by bending and twisting. The elastic deforming part 44-2 in the connector part 40-5 can have a different shape such as character “U” shape and another shape according to demand instead of the circular arc shape.

### (Other Modifications)

The electrical connector assembly according to each of the first to seventh embodiments of the present invention shown in FIG. 1 to FIG. 10 has the terminal fixing part of a compressed shape where the adjacent helical parts are adhered and compressed and close to each other. However, the concept of the present invention is not limited by the embodiments previously described. It is sufficient for the terminal fixing part to have a capability of elastically fastening the lead part of the electrical component 10. For example, it is possible for the terminal fixing part to have a structure of a space winding part where a line spring member is wound with a predetermined pitch space.

In addition, each of the embodiments shows the fixed end part which is fixed onto the land part 32 by solder. However, the concept of the present invention is not limited by the embodiments previously described. For example, it is possible to fix the fixed end part to the land part by pressure welding.

Each of the embodiments shows the lead part 11 of the electrical component 10 having a square cross section. However, the concept of the present invention is not limited by the embodiments previously described. It is possible for the lead part 11 of the electrical component 10 to have an elliptic cross section or a rectangle cross section, for example. That is, the lead part 11 of the electrical component 10 can have various shapes of cross section as long as the terminal fixing part can elastically fasten the lead part.

In the third and sixth embodiments, it is possible that the concentric circle part 42-1 is fixed onto the land part formed on the back surface (second surface) of the printed circuit board 30, and possible to form the elastic deforming part 44-1 on the front surface (first surface) of the printed circuit board 30 by passing the elastic deforming part 44 through the through hole 31. Further, in the fifth embodiment, it is possible that the elastic deforming part 44-1 is placed on the front surface (first surface) of the printed circuit board 30.

It is also possible to form a solder fillet by adding the structure of the fourth embodiment to the structure of each of the second, third, sixth, and seventh embodiments so that the fixed end part has the vertical part 45, and the outer peripheral surface of the vertical part 45 and the concentric circle part are covered with solder.

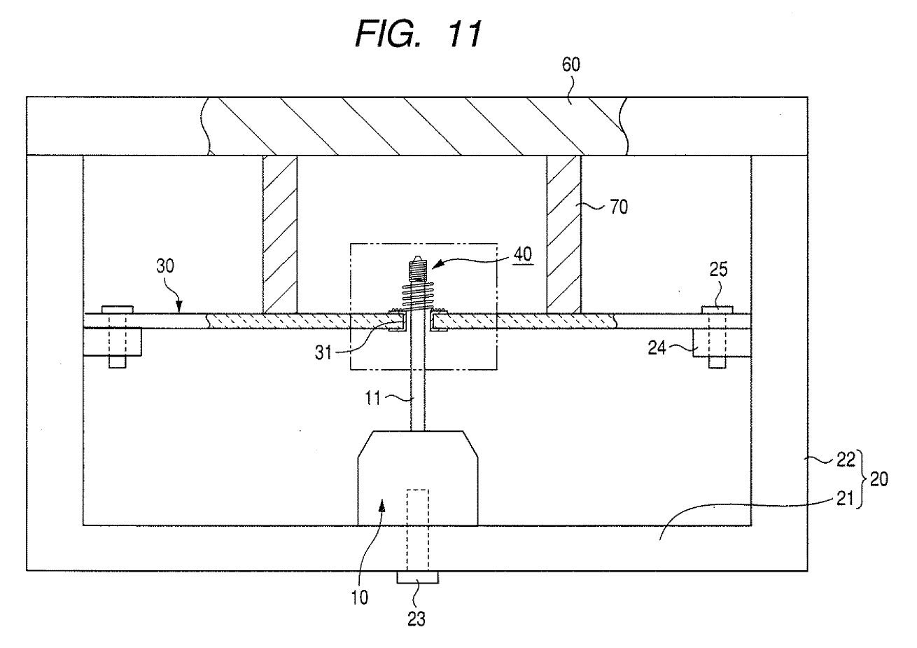

FIG. 11 is a view showing a cross section of the electric device having the electrical connector assembly according to another modification of the present invention. The printed circuit board 30 and the electrical component 10 are electrically and mechanically connected together by the electrical connector assembly.

As shown in FIG. 11, it is further possible for the case 20 to have a cap 60 and a buffer member (or a shock absorbing member) 70 between the cap 60 and the printed circuit board 30.

The cap 60 is placed at the back surface of the printed circuit board 30 in parallel to the printed circuit board 30 in order to cover the printed circuit board 30. For example, the cap 60 is fixed to the case 20 by inserting it under pressure. The buffer member 70 made of elastic member is placed between the cap 60 and the printed circuit board 30. The printed circuit board 30 is pressed toward the bottom surface side 21 of the case 20. This makes it possible to suppress the printed circuit board 30 from being warped and vibrated by thermal expansion, and thereby to suppress the lead part 11 from sliding in the position to the coil spring.

The first to seventh embodiments previously described show the electric device 1 having the electrical connector assembly in which the lead part 11 is inserted into the coil spring so that the printed circuit board 30 and the electrical component 10 are electrically and mechanically connected together. It is possible to apply the connector part as the electrical connector assembly to various types of electric devices as long as the electric devices can use the electrical connector assembly.

### Eighth Embodiment

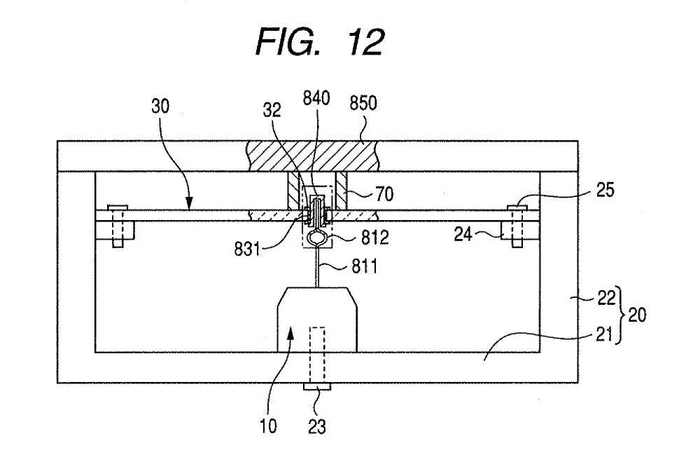

A description will now be given of the electrical connector assembly according to the eighth embodiment of the present invention with reference to FIG. 12.

FIG. 12 is a view showing a cross section of the electric device having the electrical connector assembly according to the eighth embodiment of the present invention. The printed circuit board 30 and the electrical component 10 are electrically and mechanically connected by the electrical connector assembly.

As shown in FIG. 12, the electric device has the electrical component 10, the case 2, and the connector part 840 and the cap 850.

The case 20 has a side wall surface part 22 and a bottom surface part 21. The electrical component 10 is placed on the bottom surface part 21 of the case 20. The electrical component 10 is fixed onto the bottom surface part 21 of the case 20 by a screw part 23. The electrical component 10 has a plurality of lead parts 811. FIG. 12 shows only one lead part 811 for brevity. Each of the lead parts 811 is inserted into a corresponding connector part 840 in the vertical direction which is perpendicular to the surface direction of the printed circuit board 30. This insertion of the lead part 811 makes it possible to electrically and mechanically connect the electrical component 10 to the printed circuit board 30 through the connector part 840.

Specifically, as shown in FIG. 12, the lead parts 811 of the electrical component 10 have a front tip part of a convergent shape. A cross section of the lead part 811 in the direction which is perpendicular to the inserting direction has a square shape. Each of the lead parts 811 is fixed to the printed circuit board 30 by the connector part 840, and the electrical component 10 electrically and mechanically contacts with the connector part 840. The printed circuit board 30 is thereby fixed to the case 20. The electrical component 10 is a through hole device (THD), for example.

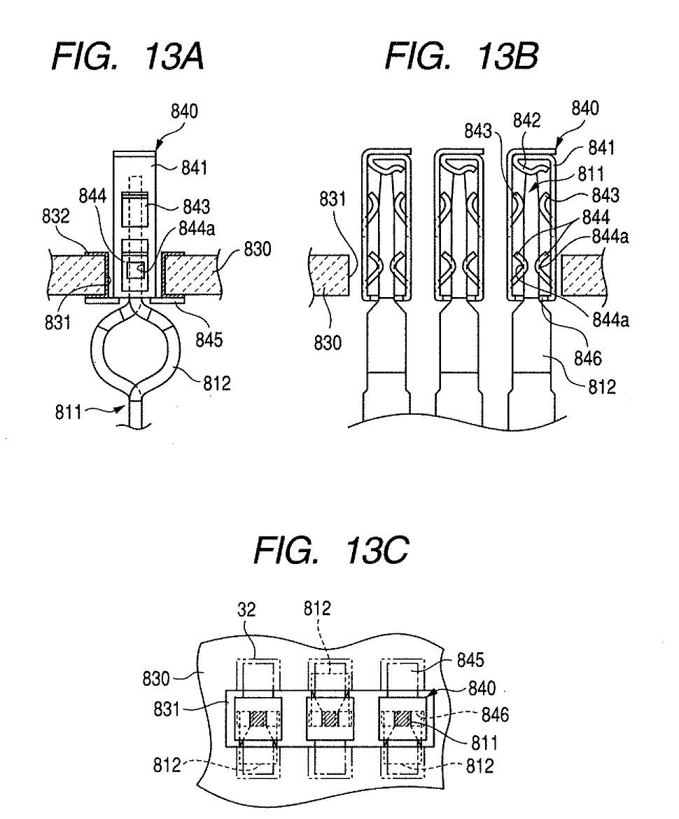

FIG. 13A is an enlarged view of the electrical connector assembly indicated by the long dashed and double dotted line shown in FIG. 12. FIG. 13B is an enlarged view of the electrical connector assembly of the printed circuit board 30 and the electrical component 10 observed from a direction which is perpendicular to the direction shown in FIG. 12. FIG. 13C is a view of the electrical connector assembly of the printed circuit board 30 and the electrical component 10 observed from a top shown in FIG. 12.

Specifically, as shown in FIG. 13A, FIG. 13B, and FIG. 13C, each of the lead parts 811 of the electrical component 10 has a convergent small part and a bent part 812. The convergent small part of the lead part 811 is inserted into the corresponding connector part 40.

The bent part 812 is a part of the lead part 811 at the electrical component 10 side when compared with the convergent small part. The bent part 812 is not inserted into the connector part 840 and formed so that the part of the lead part 811 is bent toward the vertical direction which is perpendicular to the longitudinal direction of the lead part 811, as shown in FIG. 12A. Because the shape of each bent part 812 has an elastic force, the convergent small part formed at the front part of the lead part 811 is pressed toward the inserting direction when the lead part is inserted into the connector part 840.

In the electrical connector assembly according to the eighth embodiment, the adjacent bent parts 812 project toward an opposite direction, as shown in FIG. 13C. The concept of the present invention is not limited by this structure. For example, it is possible to have the structure in which each of the bent parts 812 in the adjacent lead part 811 projects toward the same direction. However, using this structure in which the bent parts 812 of the adjacent lead parts 811 project toward a different direction can suppress the connector part 40 from tilting. That is, all of the elastic force of the bent parts 812 does not become a parallel component which is in parallel to the component to insert the lead part 811 into the connector part 840. A part of the elastic force of the bent parts 812 becomes a vertical component which is perpendicular to the parallel component. Thus, the vertical component of the elastic force tilts the connection node between the lead part 811 and the connector part 840. Therefore when the bent parts 812 in the adjacent lead parts 811 project toward a different direction, it is possible to cancel the vertical force components acting on the adjacent bent parts 812, and to suppress the lead parts 811 or the connector part 840 from tilting.

The case 20 has the bottom surface part 21 of a rectangle shape. The side wall surface part 22 stands, that is, is placed in the vertical direction at both sides of the bottom surface part 21. A supporting part 24 is formed at the inside wall surface of the side wall surface part 22. The printed circuit board 30 is mounted on the supporting parts 24 of the case 20 by screw parts 25. As shown in FIG. 12, each of the screw parts 25 screws the printed circuit board 30 onto the supporting parts 24 of the case 20 by inserting it from the main surface side of the printed circuit board 30 to the supporting parts 24. In the eighth embodiment shown in FIG. 12, the electrical component 10 faces the front surface (first surface) of the printed circuit board 30, and the connector part 840 is placed at the back surface (second surface) side of the printed circuit board 30.

The printed circuit board 30 is a circuit board composed mainly of a printed wiring substrate on which circuit wirings (not shown) are formed. A plurality of through holes 831 is formed in the printed circuit board 30. The lead part 811 of the electrical component 10 is inserted into the corresponding through hole 31. Specifically, the land 32 is formed around the peripheral part of a window part of the through hole 831 and also formed on the front surface (first surface) and the back surface (second surface) of the printed circuit board 30. Each of the land parts 32 is electrically connected to a corresponding circuit wiring formed on the printed circuit board 30.

In the structure of the electrical connector assembly according to the eighth embodiment, a plurality of the connector parts 840 is inserted into the same through hole (commonly-used through hole) 831. This structure makes it possible to avoid forming a separation wall between adjacent connector parts 840 when compared with the case where the through holes 831 are formed in the printed circuit board 30 in one to one correspondence to the connector parts 840. This structure allows the size of the connector part 840 to increase. In other words, each of the connector parts 840 has a large size. This makes it possible to easily produce the connector parts 840, in particular, to provide an easy process to bend the connector parts 840.

The connector part 840 is electrically connected to the land part 32, and thereby electrically connected to the corresponding circuit wiring formed on the printed circuit board 30. The number of the connector parts 840 is equal to the number of the lead parts 811. Each of the lead parts 811 is inserted into the corresponding connector part 840, and thereby connected to the corresponding wiring formed on the printed circuit board 30.

The connector part 840 has an attachable and detachable structure. When the lead part 811 is inserted into the corresponding connector part 840, they are electrically connected together. On the other hand, when the lead part 811 is separated from the connector part 840, the lead part 811 is released from the connector part 840.

Specifically, as shown in FIG. 13A, FIG. 13B, FIG. 13C, the connector part 840 is composed of an outer frame part 841, a front end spring part 842, a first holding spring part 843, a second holding spring part 844, and a contact part 845. Each part of them is formed by punching and bending a single steel plate.

The outer frame part 841 is a hollow member that forms an outer part of the connector part 840. The outer frame part 841 is made by bending a metal plate in a rectangle tube shape, as shown in FIG. 13B. The front end spring part 842 is placed in the longitudinal direction at one end of and in the inside of the outer frame part 841. A window part 846 is formed at the other end part of the outer frame part 841. The front end part of the lead part 811 is inserted through the window part 846 into the inside of the outer frame part 841.

The front end spring part 842 is a plate-shaped spring which is obtained by bending a front end part of the metal plate which forms the outer frame part 841 (see FIG. 13B). When the front end part of the lead part 811 contacts with the front end spring part 842 after inserted into the inside of the outer frame part 841, the elastic force of the front end spring part 842 pushes the lead part 811 of the electrical component 10 toward the direction which is opposite to the direction to insert the lead part 811 into the connector part 840.

The first holding spring part 843 and the second holding spring part 844 are formed by punching both the surfaces of the outer frame part 841, which are in parallel to the inserting direction of the lead part 811 with a desired shape, and by bending it toward the inside direction of the outer frame part 841.

Both the first holding spring part 843 and the second holding spring part 844 hold the lead part 811 in order to support the lead part 811. The first holding spring part 843 and the second holding spring part 844 are placed in series toward the inserting direction to insert the lead part 811 in the inside of the outer frame part 841. The first holding spring part 843 is placed at the front part (deeper region) in the outer frame part 841 (near the front end spring part 842). The second holding spring part 844 is placed at the rear part (near the window part 846) in the outer frame part 841.

The first holding spring part 843 has a curved part. A shown in FIG. 13B, the distance of the adjacent first holding spring parts takes a minimum value at the curved parts of the adjacent first holding spring parts 843 in the outer frame part 841. The lead part 811 is held and supported by the curved parts of the adjacent first holding spring parts 843.

Like the shape of the first holding spring part 843, the second holding spring part 844 has a curved part. A cut part 844a having the same dimension of the thickness of the lead part 811 is formed in the second holding spring part 844, as shown in FIG. 13A.

When the lead part 811 is inserted into the connector part 840, and placed between the adjacent second holding spring parts 844, the lead part 811 is fitted into the cut parts 844a formed in the adjacent second holding spring parts 844, so that both ends of the cut parts 844a in the inserting direction and the wall surfaces of the cut parts 844a in parallel to the inserting direction contact with the lead parts 811. Thus, when the lead part 811 contacts with the both ends of the cut parts 44a, the lead part 811 is fitted to the second holding spring parts 844. This prevents the lead part 811 from tilting toward the right and left direction (or horizontal direction, which is perpendicular to the plane direction of the outer frame part 841 with the second holding spring parts 844) shown in FIG. 13B. The lead part 811 thereby contact with the wall surfaces of the cut parts 844a in parallel to the inserting direction of the lead part 811. This also prevents the lead part 811 from tilting toward the vertical direction which is perpendicular to the surface of the FIG. 13B. This makes it possible to suppress the lead part 811 from tilting toward the four directions which are perpendicular together.

Further, because the first holding spring parts 843 can also suppress the lead part 811 from tilting, it is possible for the combination of the first holding spring parts 843 and the second holding spring parts 844 to more prevent the lead part 811 from tilting.

The contact part 845 is formed in the connector part 840 and placed at the rear side of the through hole 831 in the inserting direction. The contact part 845 is placed in the direction which is perpendicular to the bending direction to bend the first holding spring part 843 and the second holding spring part 844. The contact part 845 is electrically and mechanically connected and fixed to the land part 832 by solder, etc. This makes it possible to tightly fix the connector part 840 to the printed circuit board 30.

The connector part 840 having the above structure is electrically and mechanically connected to the land part 32 formed in the printed circuit board 30 by inserting the front end spring part 842 of the connector part 840 until the contact part 845 contacts to the land part 32. The connector part 840 is then fixed to the printed circuit board 30 by soldering the contact part 845 and the land part 30 together. The lead part 811 of the electrical component 10 is connected to the land part 32, which is formed at the inserting surface side of the printed circuit board 30, through the contact part 845 of the connector part 840 formed at the inserting surface side to insert the lead part 811 into the through hole 831. When the lead part 811 is inserted into the connector part 840, the inserting force to insert the lead part 811 to the inside of the connector part 840 is not applied to the direction to separate the contact part 845 from the land part 32. This makes it possible to prevent an electrical connection failure generated between the connector part 840 and the land part 32.

The cap 850 is placed on the case 20 at the opposite side of the bottom surface 21 in parallel to the printed circuit board 30. The printed circuit board 30 is covered with the cap 850. For example, the cap 850 is fixed to the case 20 by pressure inserting. The buffer member 70 is placed between the cap 850 and the printed circuit board 30. The buffer member 70 is made of elastic member, for example. The buffer member 70 presses the printed circuit board 30 toward the bottom surface 21 side of the case 20. This can suppress the printed circuit board 30 from being bent by thermal expansion and further suppress the lead part 811 from vibrating in the connector part 840.

A description will now be given of the operation to set the lead part 811 of the electrical component 10 into the connector part 840, and the operation to detach it from the connector part 840 in the electrical connector assembly according to the eighth embodiment used in the electric device 1.

The connector part 840 is fitted to the through hole 831 formed in the printed circuit board 30, and the contact part 845 is electrically and mechanically fixed to the land part 32 by solder. The lead part 811 is then inserted into the connector part 840 under the state where the electrical component 10 is fixed to the bottom surface part 21 of the case 20. The lead part 811 is thereby inserted to the inside of the connector part 840, the lead part 811 is then fitted to the cut parts 844a of the second holding spring part 844, and presses and spreads the second holding spring part 844. Further, the lead part 811 presses and spreads the second holding spring part 844, and then the first holding spring part 843, and finally reaches the front end spring part 842 placed at the deeper area in the outer frame part 841. The elastic force of the bent part 812 of the lead part 811 of the electrical component 10 presses the front end part of the lead part 811 toward the direction which is opposite to the direction to insert the lead part 811.

The elastic force of the front end spring part 842 and the elastic force of the bent part 812 are oppositely applied in direction to the front end part of the lead part 811. The front end part of the lead part 811 is fitted and fixed by these elastic forces.

The front end part of the lead part 811 is held by the first holding spring part 843 and the second holding spring part 844. This suppresses the lead part 811 from tilting toward the right and left directions in FIG. 13B, and cut part 844a of the second holding spring part 844 suppresses the lead part 811 from tilting toward the vertical direction on the sheet of FIG. 13B.

The front end part of the lead part 811 is fixed to the connector part 840, and the electrical component 10 is thereby electrically and mechanically connected to the printed circuit board 30.

On the other hand, when the lead part 811 is detached from or disengaged with the connector part 840, the printed circuit board 30 is detached from the case 20 by unscrewing and removing the screw parts 25. This makes it possible to detach the lead part 811 from the connector part 840. The electrical component 10 is thereby detached from the printed circuit board 30.

As described above, in the electrical connector assembly used in the electric device 1 according to the eighth embodiment, the elastic force of the front end spring part 842 and the elastic force of the bent part 812 are oppositely applied in direction to the front end part of the lead part 811. The front end part of the lead part 811 is thereby fitted and fixed to the connector part 840 by these elastic forces. These forces suppress the lead part 811 from tilting. This structure also suppresses the lead part 811 from sliding in the inside of the connector part 840. Accordingly, it is possible for the electrical connector assembly according to the eighth embodiment to suppress increasing the contact resistance at the contact point between the lead part 811 and the connector part 840.

Further, the printed circuit board 30 is pressed toward the bottom surface side 21 of the case 20 by the buffer member 70 in the electrical connector assembly according to the eighth embodiment. This structure makes it possible to prevent the printed circuit board 30 from bending by thermal expansion and vibrating. This further suppresses the lead part 811 from tilting toward the connector part 840.

The electrical connector assembly according to the eighth embodiment has the structure to fix the lead parts 811 by the connector part 840, and does not require any housing to fix the lead parts 811. This decreases the total number of components of the electrical connector assembly according to the eighth embodiment.

In the electrical connector assembly according to the eighth embodiment, two pairs of spring means, composed of the first holding spring part 843 and the second holding spring part 844, suppress the lead parts 811 from tilting. However, the present invention is not limited by this structure. For example, it is possible to use one pair of spring means to support the lead parts 811 in vertical and horizontal directions. Using both the spring means such as the first holding spring part 843 and the second holding spring part 844 more suppresses the lead parts 811 from tilting.

### Ninth Embodiment

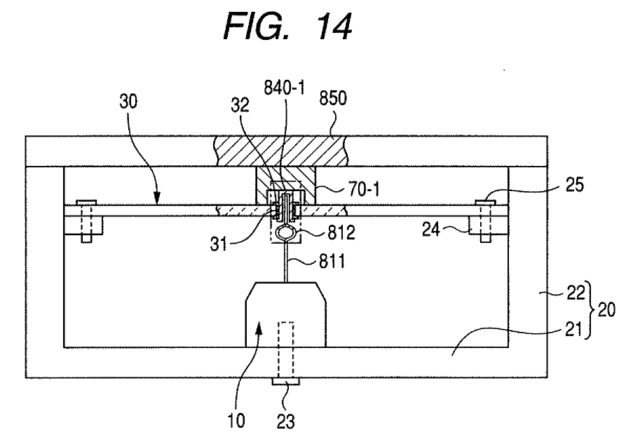

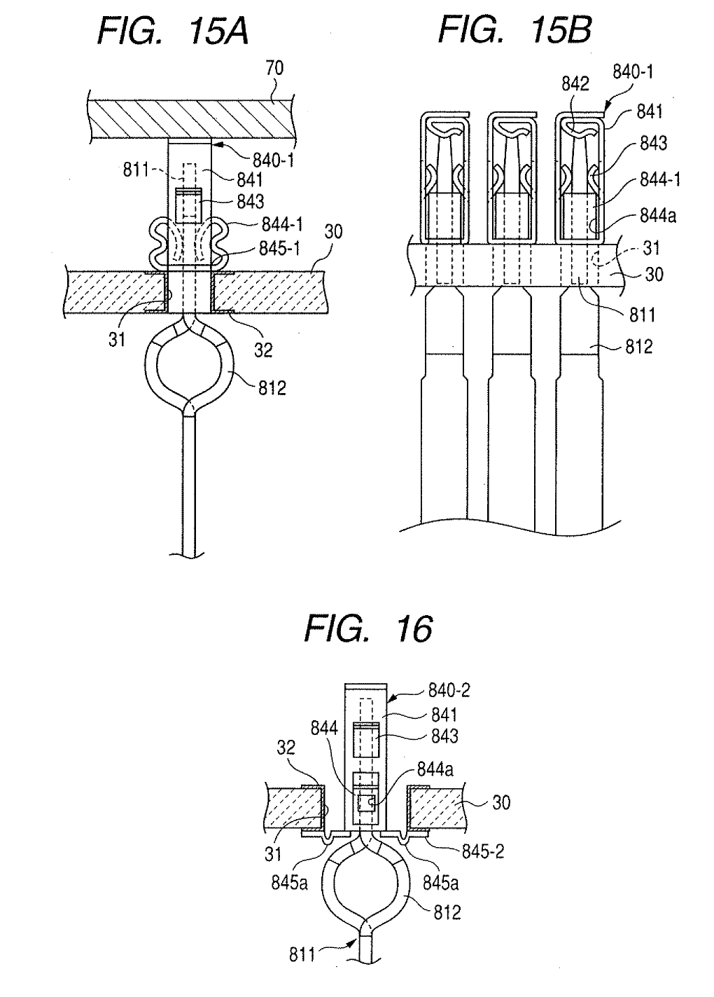

A description will now be given of the electrical connector assembly according to the ninth embodiment of the present invention with reference to FIG. 14, FIG. 15A and FIG. 15B.

The electrical connector assembly used in the electric device 1 according to the ninth embodiment has the improved connector part. Because other components of the electrical connector assembly according to the ninth embodiment have the same structure of those in the electrical connector assembly according to the eighth embodiment, the following description will be given of the different components.

FIG. 14 is a view showing a cross section of the electric device 10 having the electrical connector assembly according to the ninth embodiment of the present invention, with which the printed circuit board 30 and the electrical component 10 are electrically and mechanically connected together.

A description will now be given of the connection structure of the electrical connector assembly to electrically and mechanically connect the printed circuit board 30 and the electrical component 10 with reference to FIG. 14.

As shown in FIG. 14, the buffer member 70-1 is placed between the connector part 840-1 and the cap part 850 in addition to between the cap part 850 and the printed circuit board 30. This makes it possible for the buffer member 70-1 to press the connector part 840-1 toward the printed circuit board 30 side in addition to pressing the printed circuit board 30 toward the bottom surface 20 side.

FIG. 15A is an enlarged view of the electrical connector assembly indicated by a long dashed and double dotted line shown in FIG. 14. FIG. 15B is an enlarged view of the electrical connector assembly of the printed circuit board 30 and the electrical component 10 observed from a direction which is perpendicular to the direction shown in FIG. 14.

Specifically, like the eighth embodiment, the first holding spring part 843 is formed by punching both the surface of the outer frame part 841, which is in parallel to the inserting direction of the lead part 811 with a desired shape, and bending it toward the inside of the outer frame part 841.

However, the second holding spring part 844-1 is formed by bending the part vertically extended to the direction to bend the first holding spring part 843 at the rear end part in the direction to insert the connector part 840-1 into the through hole 31.

A part of the second holding spring part 844-1 works as a contact part 845-1 which is electrically and mechanically connected to the printed circuit board 30 by solder, etc. This makes it possible to fix the connector part 840-1 to the printed circuit board 30.

Using the first holding spring part 843 having the above structure in the electrical connector assembly according to the ninth embodiment can prevent the lead part 811 from tilting toward the right and left directions (horizontal direction) on the sheet of FIG. 15A. Further, using the second holding spring part 844-1 can prevent the lead part 811 from tilting toward the vertical direction on the surface of the sheet of FIG. 15A. The first holding spring part 843 and the second holding spring part 844-1 can prevent the lead part 811 from tilting toward the vertical direction together. The electrical connector assembly according to the ninth embodiment has the same effect of the electrical connector assembly according to the eighth embodiment.

In the structure of the connector part 840-1 according to the ninth embodiment, the contact part 845-1 contacts with the land part 32 formed at the back surface (second surface) of the printed circuit board 80, which is opposite to the front surface (first surface) of the printed circuit board 30 through which the lead part 811 of the electrical component 10 is inserted into the connector part 840-1 fitted in the through hole 31. This makes it possible to apply the inserting force to insert the lead part 811 of the electrical component 10 toward the direction to separate the contact part 845-1 from the land part 32 when the lead part 811 of the electrical component 10 is inserted in the inside of the connector part 840-1. However, because the connector part 840-1 is pressed toward the printed circuit board 830 side by the buffer member 70-1 placed between the cap part 850 and the connector part 840-1, it is thereby possible to avoid an electrical connection failure generated between the connector part 840-1 and the land part 32 even if the inserting force is applied to the direction to separate the contact part 845-1 from the land part 32 when the lead part 811 is inserted into the connector part 840-1.

Still further, like the structure of the electrical connector assembly according to the ninth embodiment, no structure is required to insert the connector part 840-1 into only the through hole 31, and it is possible to place the adjacent connector parts 840-1 close to each other, and it is also possible to obtain the electric device 1 with high density.

### Tenth Embodiment

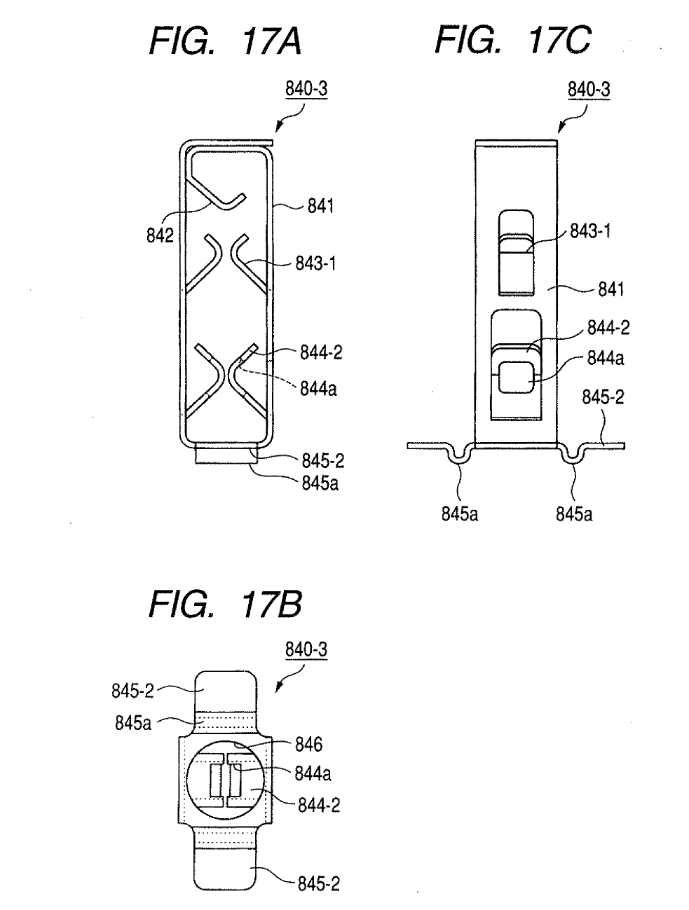

A description will now be given of the electrical connector assembly according to the tenth embodiment of the present invention with reference to FIG. 16, FIG. 17A, FIG. 17B, and FIG. 17C.

The electrical connector assembly used in the electric device 1 according to the tenth embodiment has an improved connector part 840-2. Because other components of the electrical connector assembly according to the tenth embodiment have the same structure of those in the electrical connector assembly according to the eighth embodiment, the following description will be given of the different components.

FIG. 16 is a view showing a partial enlarged part of the electrical connector assembly according to the tenth embodiment of the present invention. The printed circuit board 30 and the electrical component 10 are electrically and mechanically connected together by the electrical connector assembly. As shown in FIG. 16, bent parts 845a are formed in the contact part 845-2 of the connector part 840-2.

The bent parts 845a are formed by bending parts of the contact part 845-2 in the connector part 840-2, which do not directly contacts with the printed circuit board 830, that is, which correspond to the through hole 31.

The bent parts 845a in the contact part 845-2 can absorb the stress and suppress the transmission of the stress to area at which the contact parts 845-2 contact with the printed circuit board 30 when external force is applied to the connector part 840-2 after the connector part 840-2 is fixed to the printed circuit board 30 by soldering the connector part 840-2 to the land part 32.

### (Other Modifications)

In the eighth, ninth, and tenth embodiments as previously described, for example, as shown in FIG. 13A, each of the first holding spring part 843 and the second holding spring part 844 is formed by punching a part of the outer frame part 841 in a rectangle shape so that the front end part thereof has an angular shape. Further, for example, as shown in FIG. 13C, the contact part 845 has angular shaped corner parts. However, the present invention is not limited by the structure. It is possible for the front corner part of each of the first holding spring part, the second holding spring part, and the contact part to have another shape instead of such an angular shape.

FIG. 17A is a front view of the connector part of the electrical connector assembly according to another modification of the present invention. FIG. 17B is a bottom view of the connector part of the electrical connector assembly shown in FIG. 17A. FIG. 17C is a right side view of the connector part of the electrical connector assembly shown in FIG. 17A.

As shown in FIG. 17A, FIG. 17B, and FIG. 17C, the front end part of each of the first holding spring part 843-1, the second holding spring part 844-2, and the contact part 845-2 have another shape such as a rounded front shape.

The ninth embodiment shows the structure of the electrical connector assembly in which the elastic force of the first holding spring part 843 and the elastic force of the first holding spring part 844-1 are applied in opposite direction which is perpendicular to each other observed from the lead part 811. The ninth embodiment shows the structure in which the lead part 832 of the printed circuit board 830 contacts with the contact part 845-2 at the back surface (second surface) which is opposite to the front surface (first surface) to insert the lead part 811 into the through hole 31. However, the present invention is not limited by this.

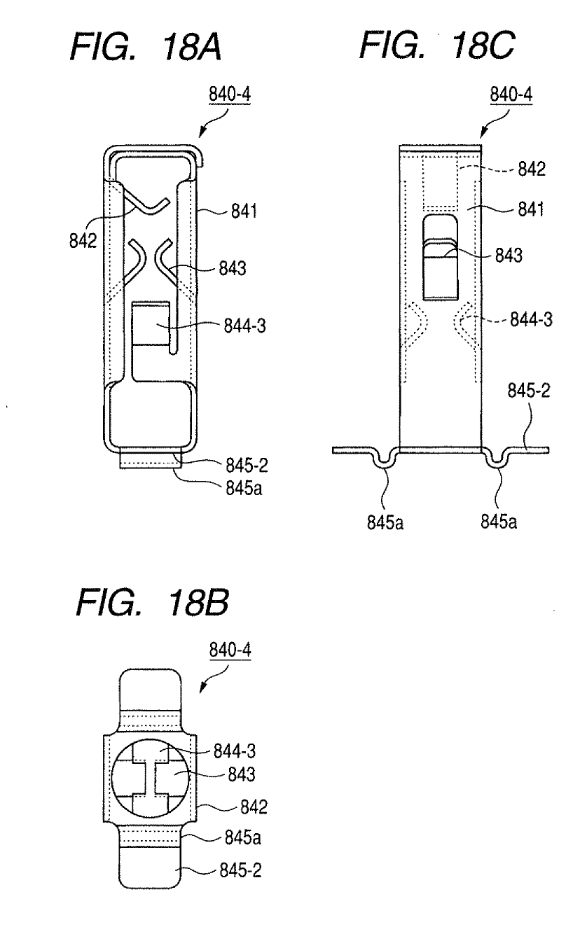

FIG. 18A is a front view of the connector part 840-4 of the electrical connector assembly according to another modification of the present invention having the above structure. FIG. 18B is a bottom view of the connector part 840-4 of the electrical connector assembly shown in FIG. 18A. FIG. 18C is a right side view of the connector part 840-4 of the electrical connector assembly shown in FIG. 18A.

It is possible to have another structure in which the elastic force of the first holding spring part 843 and the elastic force of the second holding spring part 844-3 are applied in opposite direction which is perpendicular to each other, and the connector part is fitted to the through hole 31, and the contact surface contacts with the land part 32 at the front surface (first surface) to insert the lead part 911 into the through hole 31.

As shown in FIG. 18A, FIG. 18B, and FIG. 18C, the outer frame part 841 is bent in the direction which is perpendicular to the surface to form the first holding spring part 843, and the second holding spring part 844-3 is formed at the front part of the first holding spring part 843. The contact part 845-2 is extended and formed at the rear end of the connector part 840-4 in the direction to insert the connector part 840-4 into the through hole 31. Like the structure shown in the ninth embodiment, the connector part 840-4 can have the structure to insert the connector part 40-4 into the through hole 31 under the state where the elastic force of the first holding spring part 843 and the elastic force of the second holding spring part 844-1 are applied in opposite direction which are perpendicular to each other.

Each of the eighth, ninth, and tenth embodiments and the modification, as previously described, shows the structure of the electric device 1 shown in FIG. 12 which is capable of electrically and mechanically connecting the printed circuit board 30 to the electrical component 10 by inserting and fitting the lead part 11 into the connector part. The concept of the present invention is not limited by this. It is possible to apply the connector part as the electrical connector assembly according to the present invention to various types of electric devices as long as they can utilize the electrical connector assembly.

### (Summary of the Eighth, Ninth, and Tenth Embodiments of the Present Invention)

The present invention provides an electrical connector assembly for electrically and mechanically connecting an electric component having a lead part to a printed circuit board by inserting the lead part into a connector part, and for detaching the electrical component from the printed circuit board by detaching the lead part from the connector part, the printed circuit board having a through hole into which the connector part is fitted in order to electrically connect with a land part formed around an opening peripheral part of the through hole.

In the electrical connector assembly, the lead part comprises a bent part placed at a rear part observed from a front part of the lead part, and the bent part provides an elastic force in a direction to insert the lead part into the connector part. The connector part comprises an outer frame part, a front end spring part, a first holding spring part, and a second holding spring part. The outer frame part has a hollow shape and forms an outer frame of the connector part, and the lead part is inserted in the inside of the outer frame of a hollow shape of the connector part. The front end spring part is placed at a front part of the outer frame part in the inserting direction to insert the lead part into the inside of the outer frame part of the connector part, and presses the front part of the lead part toward a direction which is opposite to the inserting direction to insert the lead part to the inside of the outer frame part of the connector part. Each of the first holding spring part and the second holding spring part is formed on both surfaces of the outer frame part in parallel to the inserting direction of the lead part, and supports the lead part in vertical and horizontal directions.

As described above, an elastic force of the front end spring part formed in the connector part and an elastic force of the bend part formed in the lead part are applied in opposite directions in order to hold the front end part of the lead part. In addition, the first holding spring part and the second holding spring part suppress the lead part of the electrical component from tilting. This makes it possible to suppress the lead part from sliding in the connector part by external force when the lead part and the connector part are expanded by thermal energy. Therefore it is possible to suppress increasing the contact resistance at the contact point between the lead part and the connector part as the electrical connection terminals.

In the electrical connector assembly according to the present invention, each of the first holding spring part and the second holding spring part is formed by punching both the surfaces of the outer frame part in a desired shape, which is in parallel to the inserting direction to insert the lead part, and bending it toward the inside of the outer frame part. The first holding spring part and the second holding spring part are placed in series along the inserting direction of the lead part.

It is possible to form the first holding spring part and the second holding spring part by punching both the surfaces of the outer frame part in parallel to the inserting direction of the lead part, and bending them. The first holding spring part and the second holding spring part are formed in series in the connector part along the inserting direction to insert the lead part into the connector part.

In the electrical connector assembly according to the present invention, each of the first holding spring part and the second holding spring part formed by punching and bending both the surfaces of the outer frame part in parallel to the inserting direction of the lead part has a cut part having the same dimension of the thickness of the lead part, and

the lead part is fitted to the cut part in order to hold and support the lead part in a direction which is perpendicular to a vertical direction of both the surfaces of the outer frame part.

It is thereby possible to support the lead part in four directions which are perpendicularly intersecting to each other by one holding spring part. This suppresses the lead part from tilting by one holding spring part. In this structure, it is possible to have a plurality of the holding spring parts, and further to more suppress the lead part from tilting by using a plurality of the holding spring parts.

In the electrical connector assembly according to the present invention, the connector part has a contact part which is extended from the rear end part of the outer frame part in the inserting direction and a direction which is perpendicular to the inserting direction of the lead part, and the contact part is fixed to the land part under a state in which the connector part is fitted into the through hole.

The connector part has the contact part formed at the rear end part of the outer frame part observed from the inserting direction to insert the connector part into the connector part placed in the through hole. When the lead part is inserted into the connector part by the inserting force, the inserting force is not applied to the direction to separate the contact part from the land part. This makes it possible to prevent an electrical connection failure between the connector part and the land part from generating.

In the electrical connector assembly according to the present invention, a contact part is formed at an end part of the outer frame part of the connector part, which is opposite to an end part of the outer frame part where the front end spring part is formed, and the contact part is connected to the land part formed at the surface of the printed circuit board, which is opposite to the surface of the printed circuit board from which the lead part is inserted into the through hole.

In the structure in which the connector part is not fitted to the through hole, it is sufficient for the through hole to have a dimension with which the lead part can pass through it. It is possible to place the connector parts close to each other. This makes it possible to obtain an electric device with high density.

The electrical connector assembly according to the present invention further comprises a buffer member with which the connector part is pressed toward the printed circuit board side.

Because the electrical connector assembly according to the present invention has the buffer member with which the connector part is pressed toward the printed circuit board side, it is possible to prevent an electric connection failure between the connector part and the land part from generating even if the inserting force to insert the lead part into the connector part is applied to the direction to separate the contact part from the land part

An electric device according to the present invention comprises a case, an electrical component, the printed circuit board, and the electrical connector assembly. The case part comprises a bottom surface and a side wall which is formed in a direction which is perpendicular to the bottom surface. The electrical component is fixed onto the bottom surface of the case part. The printed circuit board is fixed to the side wall of the case. The electrical connector assembly comprises a connector part for electrically and mechanically connecting the printed circuit board having the land part to the lead part of the electrical component by inserting the lead part into the connector part in the direction which is perpendicular to the surface direction of the printed circuit board.

### Eleventh Embodiment

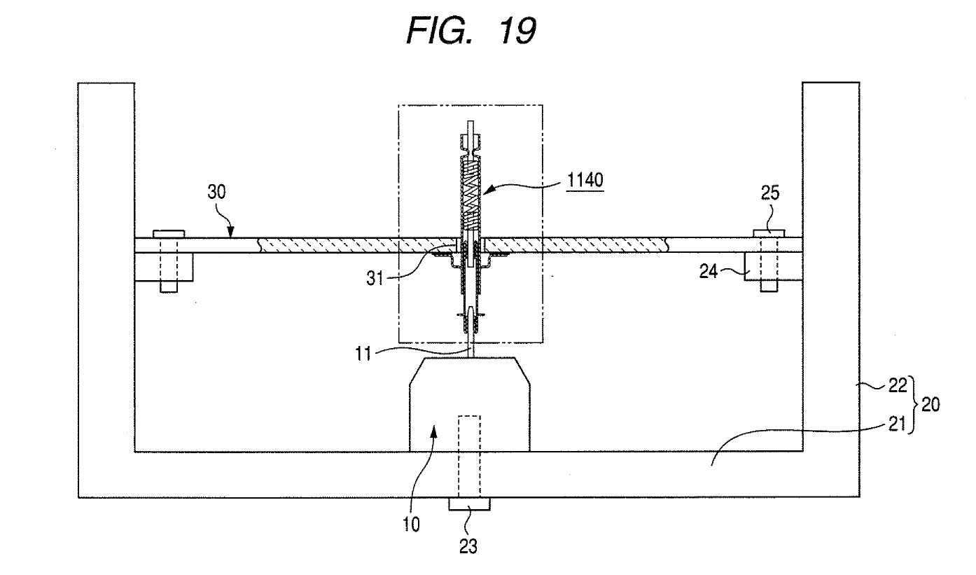

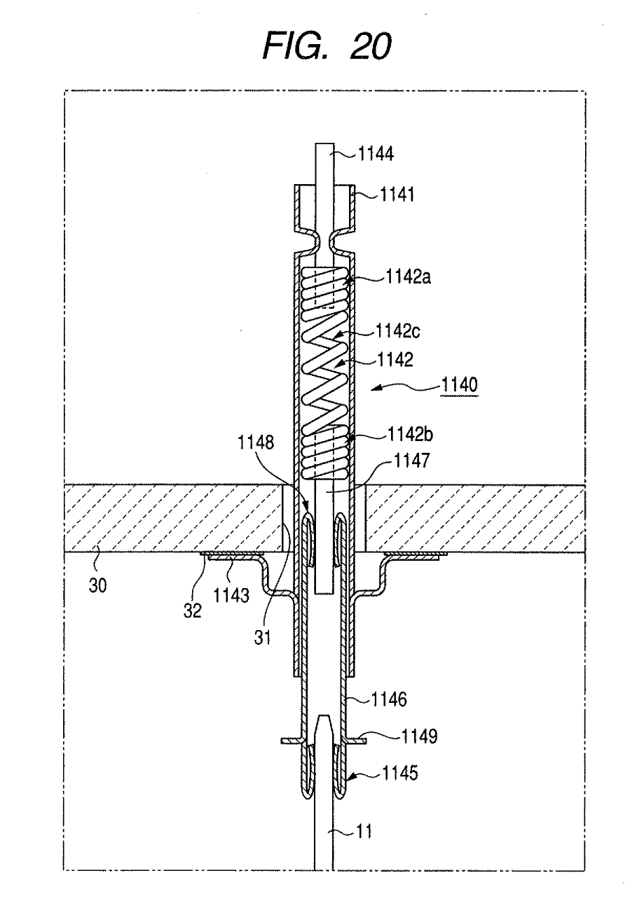

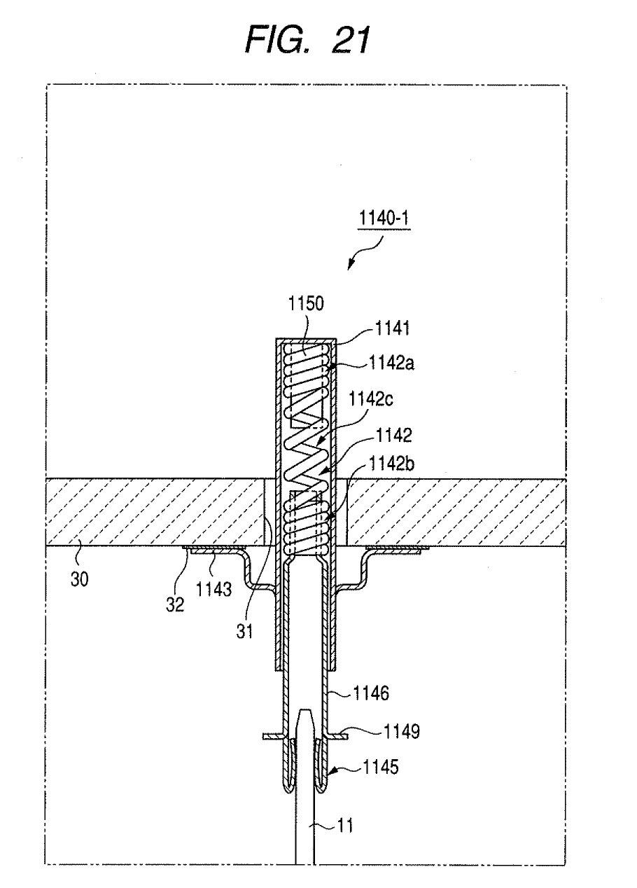

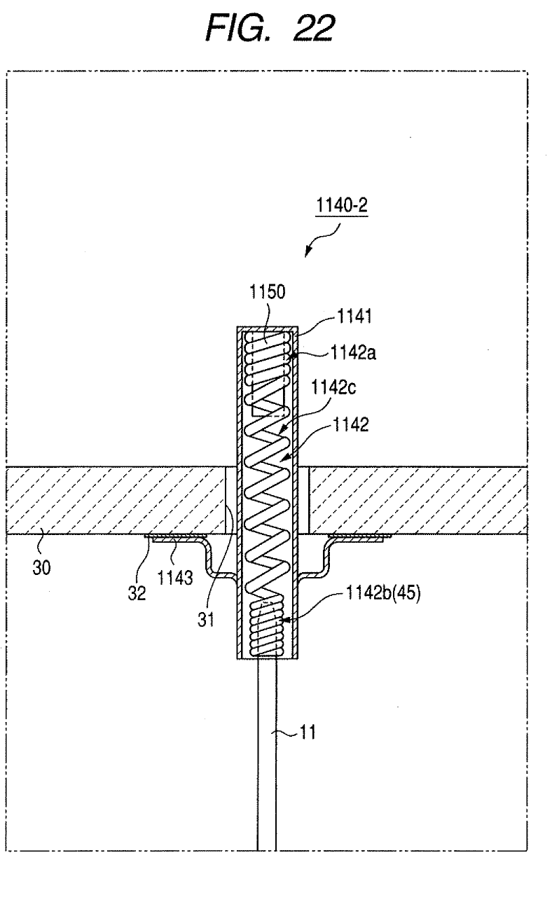

A description will be given of the electrical connector assembly according to the eleventh embodiment of the present invention with reference to FIG. 19 and FIG. 20.

FIG. 19 is a view showing a cross section of the electric device having the electrical connector assembly according to the eleventh embodiment of the present invention. The printed circuit board 30 and the electrical component 10 are electrically and mechanically connected by the electrical connector assembly. FIG. 20 is an enlarged view of the electrical connector assembly indicated by a long dashed and double dotted line shown in FIG. 19.

As shown in FIG. 19, the electric device 1 has the electrical component 10, the case 20, the printed circuit board 30, and the connector part 1140.

The case 20 has the side wall surface part 22 and the bottom surface part 21. The electrical component 10 is placed on the bottom surface part 21 of the case 20. The electrical component 10 is fixed onto the bottom surface part 21 of the case 20 by a screw part 23. The electrical component 10 has a plurality of lead parts 11. Each of the lead parts 11 is inserted into the coil spring 40 in the vertical direction which is perpendicular to the surface direction of the printed circuit board 30. This insertion makes it possible to electrically and mechanically connect the electrical component 10 to the printed circuit board 30 through the coil spring 40.

Specifically, as shown in FIG. 20, each of the lead parts 11 of the electrical component 10 has a front tip part of a convergent shape and a cross section of the lead part 11 in the direction which is perpendicular to the inserting direction has a square shape. Each of the lead parts 11 is fixed to the printed circuit board 30 by the coil spring 40, and the electrical component 10 electrically and mechanically contacts with the coil spring 40. The electrical component 10 is a through hole device (THD), for example.

As shown in FIG. 19, the bottom surface part 21 of the case 20 has a rectangle shape. A side wall surface part 22 stands, that is, is placed in the vertical direction at both sides of the bottom surface part 21. A supporting part 24 is formed at the inside wall surface of the side wall surface part 22. The printed circuit board 30 is mounted on the supporting parts 24 of the case 20 by screw parts 25. As shown in FIG. 20, each of the screw parts 25 screws the printed circuit board 30 onto the supporting parts 24 of the case 20 by inserting it from the main surface side of the printed circuit board 30 to the supporting parts 24. The printed circuit board 30 is thereby fixed to the case 20.

The printed circuit board 30 is a circuit board which is composed mainly of a printed wiring substrate, on which circuit components and wiring are mounted. A plurality of through holes 1131 is formed in the printed circuit board 30. A land part 32 is formed around the through holes 31 on the front surface (first surface) of the printed circuit board 30, and further formed on the inside wall surface of the through holes 1131.

In the eleventh embodiment, a cross section of the through hole 1131 has a rectangle shape. The through hole 1131 corresponds to the lead part 11 in one to one correspondence. The land part 32 is formed every through hole 1131. The land part 32 is formed on the front surface (first surface) of the printed circuit board 30 around the through hole 1131 having a rectangle shaped cross section. Each land 32 is electrically connected to a corresponding circuit wiring formed on the printed circuit board 30.

The connector part 1140 is electrically connected to the corresponding circuit wiring formed on the printed circuit board 30 when the connector part 1140 is electrically connected to the land 32.

The connector part 1140 is formed in one to one correspondence to the lead part 11 of the electric component 10. When each lead part 11 is inserted into the corresponding connector part 1140, the lead part 11 is electrically and mechanically connected to the connector part 1140. The connector part 1140 has a detachable structure to mount and detach the lead part 11. That is, when the lead part 11 of the electrical component 10 is inserted into the connector part 1140, the lead part 11 is fitted to the connector part 1140, and they are electrically and mechanically connected together. On the other hand, when the lead part 11 is pulled from the connector part 1140, the lead part 11 is detached from the connector part 1140, and they are electrically and mechanically disconnected.

Specifically, as shown in FIG. 20, the connector part 1140 is composed mainly of an outer case 1141, and a coil spring 1142. The outer case 1141 accommodates the coil spring 1142.

A description will now be given of the structure of the connector part 1140. In the eleventh embodiment, the coil spring 1142 corresponds to an elastic member. For example, the coil spring 1140 is made of stainless steel which is plated with copper (Cu), and further plated with gold (Au).

The outer case 1141 has an approximate rectangle hollow shape. For example, the outer case 1141 is made by punching and bending a metal plate in a desired shape. The outer case 1141 has a solder part 1143 which is formed at a rear end thereof in the inserting direction to insert the outer case 1141 into the through hole 31.

The outer case 1141 is fitted to the through hole 31 when the solder part 1143 contacts with the land part 32. The solder part 1143 is fixed to the land part 32 by solder (not shown). This structure of the electrical connector assembly makes it possible to electrically and mechanically connect the solder part 1143 of the outer case part 1141 to the land part 32.

It is possible to avoid applying the inserting force in the direction to separate the solder part 1143 from the land part 32 when the lead part 11 of the electrical component 10 is inserted into the connector part 1140 because the solder part 1143 is fixed to the land part 32 at the front surface (first surface) side of the printed circuit board 30. The first surface of the printed circuit board 30 faces the electrical component 10. This structure of the electrical connector assembly makes it possible to suppress generating an electrical connection failure between the solder part 1143 and the land part 32, that is, to suppress separating the solder from the solder part 1143 or the land part 32.

The coil spring 1142 is fixed to the outer case 1141 at a fixed end part 1142a composed of an end part (wound spiral part) of the coil spring 1142. Specifically, the coil spring 1142 fixes a first supporting member 1144 which projects from the fixed end part 1142a side of the coil spring 1142. Thus, the coil spring 1142 is fixed to the outer case 1141 through the first supporting member 1144 by fixing the first supporting member 1144 to the outer case 1141.

The first supporting member 1144 has a square pole shape whose vertical cross section in a direction which is perpendicular to the axial direction of the outer case 1141 is a square shape.

The diagonal line of the cross section of the first supporting member 1144 is longer than an inner diameter of the fixed end part 1142a. The first supporting member 1144 is pressed and fitted to the fixed end part 1142a. This makes it possible to elastically fasten and fix the first supporting member 1144 to the inside of the fixed end part 1142a.

As shown in FIG. 20, the fixed end part 1142a is fixed to the outer case 1141 by pushing the surface at the end part 1141b of the outer case 1141, which is opposite to the end part where the electrical component 10 is placed.

For example, the first supporting member 1144 is made of copper rich metal. When one winding of the coil spring 42 is a helical line part, the fixed end part 1142a has a compressed shape where the adjacent helical parts are adhered tightly and close to each other.

Further, the coil spring 1142 has a movable end part 1142b composed of the other end part (wound spiral part) which is opposite to the fixed end part 1142a. In the eleventh embodiment, the connector part 1140 further has an inner case 1146 having a terminal fixing part 1145. The inner case 1146 stops the movable end part 1142b moving.

Specifically, the movable end part 1142b fixes a second supporting member 1147 which projects from the movable end part 1142b side, like the fixed end part 1142a. The second supporting member 1147 has a square pole shape whose vertical cross section is a square shape in a direction which is perpendicular to the axial direction of the outer case 1141, like the shape of the first supporting member 1144. The diagonal line of the cross section of the second supporting member 1147 is longer than an inner diameter of the fixed end part 1142a. The second supporting member 1147 is pressed and fitted to the movable end part 1142b.

For example, like the first supporting member 1144, the second supporting member 1147 is made of copper rich metal. When one winding of the coil spring 42 is a helical line part, the movable end part 1142b has a compressed shape where the adjacent helical parts are adhered tightly and close to each other.

The inner case 1146 has an approximate square pole shape having a hollow part. As shown in FIG. 20, the dimension of the outside wall part is smaller than the dimension of the inside of the outer case 1141, and surfaces which face to each other are longer than the other surfaces which face to each other, and both the end parts have projecting parts.

The inner case 1146 has holding spring parts which are obtained by bending the projecting parts of the end parts of the inner case 1146 toward the inside direction of the inner case 1146.

In the eleventh embodiment, the holding spring parts at one end part (the bottom side in FIG. 20) in the inner case 1146 form the terminal fixing part 1145, and the holding spring parts at the other end part (the upper side in FIG. 20) in the inner case 1146 form the fixing part 1148 for fixing the second supporting member 1147.

The holding spring parts are bent at the front part thereof. At the bent part, the interval between the adjacent holding spring parts has the minimum distance.

The distance between the bent parts of the holding spring parts which form the terminal fixing part 1145 is shorter than one side of a cross section of the terminal fixing part 1145 in a direction which is perpendicular to the inserting direction to insert the lead part 11 into the connector part 1140.

The distance between the holding spring parts which form the fixing part 1148 is shorter than one side of a cross section of the inner case 1146 in the direction which is perpendicular to the axial direction of the outer case 1141 having the second supporting member 1147. For example, the inner case 1146 having the above structure is made of phosphor bronze, like the outer case 1141, made by punching and bending a metal plate in a desired shape.

The end part of the second supporting member 1147, which is opposite to the other end part fitted to the movable end part 1142b, is pressed and fitted to the fixing part 1148 of the inner case 1146. This makes it possible to elastically fasten and fix the second supporting member 1147 by the fixing part 1148, and the inner case 1146 is thereby fixed to the movable end part 1142b by the second supporting member 1147. That is, the connector part 1140 according to the eleventh embodiment has the structure in which the movable end part 1142b is equipped with the terminal fixing part 1145.

The inner case 1146 is placed in the hollow part of the outer case 1141 so that the terminal fixing part 1145 projects from the outer case 1141. A pulling fin 1149 is formed at the projecting part of the outer case 1141, which is separated from the end part of the electrical component 10 by a predetermined distance. The pulling fin 1149 is fixed by a jig (not shown) when the lead part 11 is pulled from the terminal fixing part 1145 of the connector part 1140.

The coil spring 1142 further has a deforming part 1142c which is formed between the fixed end part 1142a and the movable end part 1142b.

The deforming part 1142c is composed of a space winding part which is wound with a predetermined pitch space between adjacent helical parts. The deforming part 1142c can be elastically deformed toward the axial direction of the outer case 1141 when the lead part 11 is fixed to the connector part 1140 by the terminal fixing part 1145.

Further, the connector part 1140 is formed so that the elastic force of the terminal fixing part 1145 to fasten and fix the lead part 11 and the elastic force of the fixing part 1148 to fasten and fix the second supporting member 1147 become greater than the elastic force of the coil spring 1142 when the lead part 11 of the electrical component 10 is inserted into the terminal fixing part 1145 of the connector part 1140. That is, the connector part 1140 is formed so that the terminal fixing part 1145 is deformed by the deformation of the deforming part 1142c when the lead part 11 is pressed by external force.

The lead part 11 is inserted into the terminal fixing part 1145 of the connector part 1140 from the direction which is perpendicular to the surface of the printed circuit board 30. The lead part 11 is elastically fastened and fixed to the terminal fixing part 1145. That is, the electrical component 10 is mechanically fixed to the printed circuit board 30 by inserting the lead part 11 and fixing the lead part 11 to the terminal fixing part 1145. The electrical component 10 is electrically connected to the printed circuit board 30 through the connector part 1140 which is composed of the terminal fixing part 1145, the inner case 1146, the coil spring 1142, and the outer case 1141.

A description will now be given of the operation to mount the lead part 11 of the electrical component 10 to the coil spring 1140 and the operation to detach the lead part 11 of the electrical component 10 in the electrical connector assembly according to the eleventh embodiment of the present invention.

The lead part 11 of the electrical component 10 is inserted with a pressure into the terminal fixing part 1145 from the front surface side of the printed circuit board 30 in order to connect the electrical component 10 to the printed circuit board 30. As previously described, because the distance between the holding spring parts which form the terminal fixing part 1145 is shorter than one side of a cross section of the terminal fixing part 1145 in a direction which is perpendicular to the inserting direction of the lead part 11, the lead part 11 is elastically fastened and fixed by the terminal fixing part 1145. This makes it possible to electrically and mechanically connect the electrical component 10 to the printed circuit board 30.

When the lead part 11 is fixed to the terminal fixing part 1145, it is necessary to have a predetermined gap between the end part of the outer case 1141 and the pulling fin part 1149 at the electrical component 10 side.

When the end part of the outer case 1141 contacts with the pulling fin part 1149, inner case 1146 cannot be deformed toward the inserting direction of the lead part 11. That is, the terminal fixing part 1145 cannot be deformed toward the inserting direction of the lead part 11.

For example, it is preferable to have a predetermined gap between the end part of the outer case 1141 and the pulling fin part 1149 at the printed circuit board 30 side by detaching the jig (not shown) after completion of the pressing insertion to insert the lead part 11 to the terminal fixing part 1145 under the state where the jig having the predetermined gap is placed between the end part of the outer case 1141 and the pulling fin part 1149 at the electrical component 10 side.

When the lead part 11 is detached from the printed circuit board 30, for example, the lead part 11 is detached from the terminal fixing part 1145 under the state where the pulling fin part 1149 is fixed by the jig (not shown). This makes it possible to electrically and mechanically detach the electrical component 10 from the printed circuit board 30.

As described above, according to the electric device 1 equipped with the electrical connector assembly composed of the connector part 1140 according to the eleventh embodiment, it is possible to suppress the lead part 11 from sliding at the contact point between the lead part 11 and the terminal fixing part 1145 because the deforming part 1142c is elastically deformed when external force is applied to the lead part 11. This makes it possible to suppress a contact resistance between the lead part 11 and the terminal fixing part 1145 from sliding.

Further, when external force is applied to the lead part 11 of the electrical component 10, the deforming part 1142c is deformed to consume the external force. This makes it possible to prevent the external force from remaining in the lead part 11 when the external force is applied to the lead part 11, and thereby to avoid the lead part 11 breaking. It is also possible to suppress the external force from being applied to the solder with which the solder part 1143 is fixed to the land part 32. This makes it possible to suppress the separation of solder from the solder part 1143 and the land part 32.

### Twelfth Embodiment

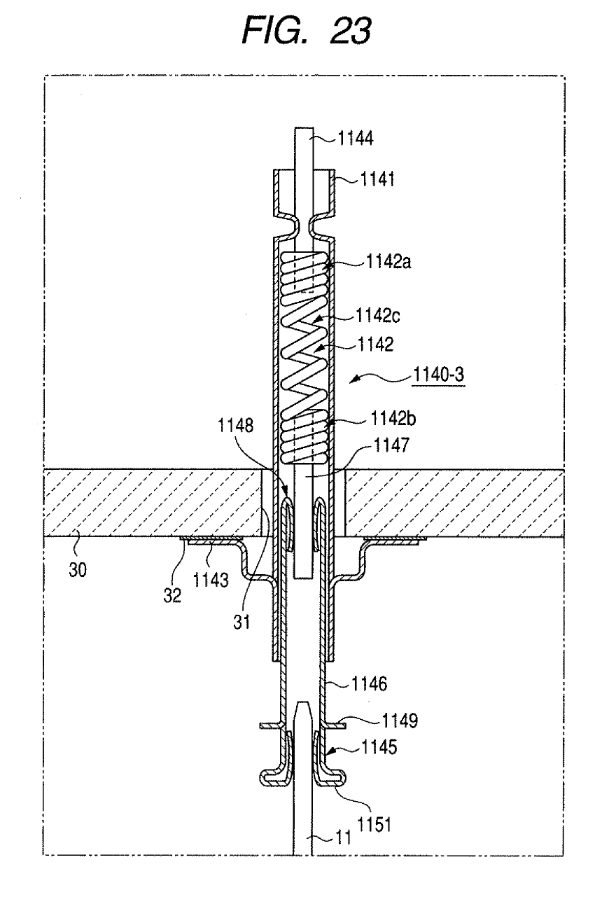

A description will be given of the electrical connector assembly according to the twelfth embodiment of the present invention with reference to FIG. 21.

The connector part 1140-1 as the electrical connector assembly according to the eleventh embodiment has the structure in which the fixed end part 1142a is directly fixed onto the inside of one end part of the outer case 1141. Because other components of the connector part 1140-1 as the electrical connector assembly according to the twelfth embodiment have the same structure of those in the connector part 1140 according to the eleventh embodiment, the following description will be given of the different components.

FIG. 21 is a view showing a partial enlarged part of the electric device 1 having the electrical connector assembly according to the twelfth embodiment of the present invention. The printed circuit board 30 and the electrical component 10 are electrically and mechanically connected together by the connector part 1140-1 as the electrical connector assembly.

FIG. 21 shows the partial enlarged view of the connector part 1140-1 according to the twelfth embodiment, which corresponds to the part of the diagram which is designated by the long dashed and double dotted line shown in FIG. 19.

As shown in FIG. 21, in the connector part 1140-1 in the electric device 1 according to the twelfth embodiment, the outer case 1141 is composed of a square pole member having the bottom surface part and a fixed part 1150 which projects along the axial direction of the outer case 1141 observed from the bottom surface part.

The fixed part 1150 has a square cross section in the direction which is perpendicular to the axial direction of the outer case 1141. The diagonal line of the square cross section of the outer case 1141 is longer than the inner diameter of the fixed end part 1142a.

The inner case 1146 has a convergent end shape at the end part which is opposite to the end part thereof at the terminal fixing part 1145 side. Specifically, the end part of the inner case 1146 has a square cross section in the direction which is perpendicular to the axial direction of the outer case 1141, and the diagonal line of the cross section of the inner case 1146 is longer than the inner diameter of the movable end part 1142b.

The coil spring 1142 is directly fixed to the outer case 1141 by pressing the fixed part 1150 to the fixed end part 1142a, and elastically fastening the fixed part 1150 by the fixed end part 1142a.

The coil spring 1142 has the terminal fixing part 1145 at the movable end part 1142b side by elastically fastening the end part of the inner case 1146 with the movable end part 1142b.

The electrical connector assembly in the electric device 1 according to the twelfth embodiment has the same effects of the electrical connector assembly according to the eleventh embodiment. When compared with the connector part 1140 as the electrical connector assembly according to the eleventh embodiment, because the connector part 1140-1 according to the twelfth embodiment does not have the first supporting member 1144 and the second supporting member 1147, it is possible to decrease the total number of the components which form the connector part 1140-1.

### Thirteenth Embodiment

A description will be given of the electrical connector assembly according to the thirteenth embodiment of the present invention with reference to FIG. 22.

The connector part 1140-2 as the electrical connector assembly according to the thirteenth embodiment has the structure in which the movable end part 1142b of the coil spring 1142 serves as the terminal fixing part 1145

Because other components of the electrical connector assembly according to the thirteenth embodiment have the same structure of those in the electrical connector assembly according to the eleventh embodiment, the following description will be given of the different components.

FIG. 22 is a view showing a partial enlarged part of the electric device 1 having the electrical connector assembly according to the thirteenth embodiment of the present invention. The printed circuit board 30 and the electrical component 10 are electrically and mechanically connected together by the connector part 1140-2 as the electrical connector assembly.

FIG. 22 shows the partial enlarged view of the connector part 1140-2 according to the twelfth embodiment, which corresponds to the part of the diagram which is designated by the long dashed and double dotted line shown in FIG. 19.

As shown in FIG. 22, in the electric device having the connector part 1140-2, the inner diameter of the movable end part 1142b is smaller than the diagonal line of the cross section in a direction which is perpendicular to the inserting direction of the lead part 11.

The lead part 11 of the electronic component 10 is inserted to the movable end part 1142b in a direction which is perpendicular to the surface direction of the printed circuit board 30, and is elastically fastened by the movable end part 1142b. That is, the movable end part 1142b of the coil spring 1142 works as the terminal fixing part 1145 to elastically fasten and fix the lead part 11.

The connector part 1140-2 according to the thirteenth embodiment has the same effects of the connector part 1140 according to the eleventh embodiment. The structure of the connector part 1140-2 according to the thirteenth embodiment decreases the total number of the components forming the connector part when compared with the structure of the connector part 1140-1 according to the twelfth embodiment.

In the thirteenth embodiment, it is possible to connect the electrical component 10 to the printed circuit board 30 by the following steps.

First, a penetration hole is formed in the side wall of the outer case 1141, and the deforming part 1142c is fixed by inserting a jig (not shown) into the hollow part of the outer case 1141 through the penetration hole. When the lead part 11 is pressed and inserted into the terminal fixing part 1145, the deforming part 1142c does not become a compressed shape where the adjacent helical parts are compressed and close to each other.

When the lead part 11 is detached from the printed circuit board 30, for example, the jig (not shown) is placed at the end part of the outer case 1141 at the electrical component 10 side, the lead part 11 is pulled or detached from the terminal fixing part 1145 so that the terminal fixing part 1145 is not pulled from the terminal fixing part 1145.

### (Other Modifications)

In the connector part 1140 as the electrical connector assembly according to the eleventh embodiment, the first supporting member 1144 is inserted into the fixed end part 1142a, and the second supporting member 1147 is inserted into the movable end part 1142b. The present invention is not limited by the structure. For example, it is possible to have another structure in which the fixed end part 1142a and the first supporting member 1144 are fixed together by welding, and the movable end part 1142b and the second supporting member 1147 are fixed together by welding.

In the connector parts 1140-1 and 1140-2 as the electrical connector assembly according to the twelfth and thirteenth embodiments, the coil spring 1142 is fixed to the outer case 1141 by inserting the fixed part 1150 into the fixed end part 1142a with pressure. The present invention is not limited by the structure. For example, it is possible to have another structure in which the outer case 1141 has a square pole member having the bottom surface part without the fixed part 1150, and the fixed end part 1142a is fixed to the bottom surface part by welding.

Each of the eleventh, twelfth, and thirteenth embodiments previously described shows the example in which the lead part 11 has a square cross section in a direction which is perpendicular to the inserting direction to insert the lead part 11. It is possible for the lead part 11 to have various types of an elliptic cross section, a round cross section, etc, in addition to the rectangle cross section. That is, the lead part 11 has various shapes in cross section as long as the lead part 11 can be elastically fastened by the terminal fixing part 1145 according to demands.

Each of the eleventh, twelfth, and thirteenth embodiments previously described shows the structure to fix the solder part 1143 to the land part 1132 by solder. For example, it is possible to fix the solder part 1143 to the land part 1132 by pressure welding.

Further, each of the eleventh, twelfth, and thirteenth embodiments previously described shows the example to use the coil spring 1142 as the elastic member. For example, it is possible to use a plate spring as the elastic member.

Still further, each of the eleventh, twelfth, and thirteenth embodiments previously described shows that the fixed end part 1142a and the movable end part 1142b have a compressed shape where the adjacent helical parts are compressed and close to each other. It is possible to use the fixed end part 1142a and the movable end part 1142b which are composed of a space winding part which is wound with a predetermined pitch space between adjacent helical parts as long as the fixed end part 1142a and the movable end part 1142b can fix the first supporting member 1144, the second supporting member 1147, the fixed part 1150, and/or the inner case 1146.

It is possible for the electric device 1 to have the connector part having a structure as a combination of at least two of the connector parts 1140, 1140-1, and 1140-2. For example, in a structure as a combination composed of the connector parts 1140 and 1140-1 according to the eleventh and twelfth embodiments, the outer case 1141 has a square pole shape having the bottom surface part and the fixed part 1150, and the fixed end part 1142a of the coil spring 1142 is fixed to the fixed part 1150, and the inner case 1146 is fixed to the movable end part 1142b of the coil spring 1142 through the second supporting member 1147.

Still further, it is possible to have the connector part having a structure as a combination of the eleventh embodiment and the thirteenth embodiment in which the fixed end part 1142a of the coil spring 1142 is fixed to the outer case 1141 through the first supporting member 1144, and the terminal fixing part 1145 is formed by using the movable end part 1142b of the coil spring 1142.

In the structure of the connector parts 1140 and 1140-1 according to the eleventh embodiment and the twelfth embodiment, it is possible for the inner case 1146 to have a flat surface part 1151 at one end part where the terminal fixing part 1145 is placed, as shown in FIG. 23. FIG. 23 is a view showing a partial enlarged part of the electric device 1 having the connector part 1140-3 as the electrical connector assembly according to another modification.

As shown in FIG. 23, the connector part 1140-3 has the flat surface part 1151. The flat surface part 1151 is formed at the end part of the inner case 1146 where the terminal fixing part 1145 is placed. The flat surface part 1151 is placed in parallel to the surface of the printed circuit board 30.

For example, the flat surface part 1151 is formed by bending the surfaces of the inner case 1146 which face together simultaneously when the terminal fixing part 1145 is formed.

Because the above structure allows the connector part to be placed in the through hole 31 of the printed circuit board 30 by using a suction collet which sucks the flat surface part 1151, and it is possible to easily prepare the printed circuit board with the connector part when compared with the case to place the connector part in the corresponding through hole.

Each of the eleventh, twelfth embodiment, and the thirteenth embodiment according to the present invention shows the electric device 1 as an example to use the connection structure where the electric component 10 is electrically and mechanically connected to the printed circuit board 30 by inserting the lead part to the connector part. The concept of the present invention is not limited by this. It is possible to apply the connector part as the electrical connector assembly according to the present invention to various types of electric devices as long as they can utilize the electrical connector assembly.

### (Summary of the Eleventh, Twelfth, and Thirteenth Embodiments of the Present Invention)

The present invention provides the electrical connector assembly which comprises a connector part for electrically and mechanically connecting a lead part of an electrical component to a printed circuit board having a through hole and a land part by inserting the lead part into the connector part, where the land part is formed at an opening peripheral part of the through hole, and electrically and mechanically disconnecting the electrical component from the printed circuit board by detaching the lead part from the connector part.

In the electric connector assembly, the connector part comprises an outer case of a square pole shape having a hollow part, and an elastic member is fitted to the inside of the hollow part of the outer case,

the outer case is electrically and mechanically connected to the land part when the outer case is inserted into the through hole,

the elastic member comprises an fixed end part formed at one end part of the elastic member and at which the elastic member is fixed to the outer case, a movable end part formed at the other end part which is opposite to the fixed end part, and a deforming part formed between the fixed end part and the movable end part elastically deforming in an axial direction of the outer case,

the movable end part has a terminal fixing part elastically fastening the lead part to fix the lead part,

the electrical component is mechanically fixed to the printed circuit board when the lead part is fixed by the terminal fixing part, and the electrical component is electrically connected to the printed circuit board through the connector part, and

the terminal fixing part is deformed by elastic deformation of the deforming part when the lead part is fixed to the terminal end part when external force is applied to the lead part.

In the above structure of the electrical connector assembly, when external force is applied to the lead part, because the deforming part is elastically deformed, it is possible to suppress the lead part from sliding at a contact point between the lead part and the terminal fixing part. It is therefore possible to suppress increasing of the contact resistance at the contact point between the lead part and the terminal fixing part due to sliding of the lead part at the contact point.

In addition, when applied to the lead part, external force is consumed by the deformation of the deforming part. This suppresses the external force from remaining in the lead part, and avoid breaking of the lead part.

In the electrical connector assembly according to the present invention, the connector part comprises an inner case of a rectangle pole shape having a hollow part which is fitted into the hollow part of the outer case,

the terminal fixing part is formed at one end part of the inner case,

the connector part further comprises a first supporting member and a second supporting member, the first supporting member projects from the fixed end part side of the elastic member, and the fixed end part is fixed to the outer case through the first supporting member by fixing the first supporting member to outer case. The movable end part is fixed to the inner case having the terminal fixing part through the second supporting member,

the second supporting member is fixed to the movable end part to project from the movable end part side of the elastic member at the other end part of the inner case which is opposite to the end part of the inner case at which the terminal fixing part is formed.

It is also possible for the electrical connector assembly according to the present invention to have a structure in which

the connector part has an inner case of a rectangle pole shape having a hollow part which is fitted into the hollow part of the outer case,

the terminal fixing part is formed at one end part of the inner case,

the outer case comprises a bottom surface part and a fixed part which projects from the bottom surface part in an axial direction of the outer case,

the fixed end part is fixed to the fixed part of the outer case so that the fixed end part is fixed to the outer case, and

the movable end part is fixed to the other end part of the inner case which is opposite to the end part at which the terminal fixing part is formed

In the structure of the electrical connector assembly according to the present invention, because the fixed end part is directly fixed to the outer case, and the movable end part is fixed to the inner case having the terminal fixing part, it is not necessary to have the member which is placed between the fixed end part and the outer case and the member which is placed between the movable end part and the inner case. This structure can decrease the total number of components which form the electrical connector assembly.

It is also possible for the electrical connector assembly according to the present invention to have a structure in which

the outer case comprises a bottom surface part and a fixed part which projects from the bottom surface part in an axial direction of the outer case,

the elastic member is a spring coil,

the fixed end part is a wound part at one end part of the coil spring, and elastically fastens the fixed end part and fixes it to the outer case, and

the movable end part is a wound part at the other end part of the coil spring, which is opposite to the end part of the coil spring at which the fixed end part is formed, and the movable end part serves as the terminal fixing part to fix the lead part.

In the above structure of the electrical connector assembly, the elastic member is a coil spring, and the terminal fixing part as the movable end part is formed at the other end part of the coil spring. This structure can decrease the total number of the components of the electrical connector assembly because the movable end part serves as the terminal fixing part.

It is also possible for the electrical connector assembly according to the present invention to have a structure in which

the outer case is inserted into the through hole at a surface of the printed circuit board which faces the electrical component side,

the outer case comprises a solder part at an outer wall surface thereof,

the solder part of the outer case is fixed to the land part formed on the printed circuit board by solder under a state in which the outer case is fitted into the through hole.

In the above structure of the electrical connector assembly, the solder part formed on, the outer peripheral wall surface and at the rear end part of the outer case is fixed and electrically connected to the land part by solder. This structure avoids applying the inserting force of the lead part into the connector part in the direction to separate the solder part from the land part.

This prevents an electrical connection failure between the outer case and the land part from occurring, that is, this structure can avoid separation of the solder from the land part and the solder part.

An electric device according to the present invention comprises a case, an electrical component, the printed circuit board, and the electrical connector assembly. The case part comprises a bottom surface and a side wall which is formed in a direction which is perpendicular to the bottom surface. The electrical component is fixed onto the bottom surface of the case part. The printed circuit board is fixed to the side wall of the case. The electrical connector assembly comprises a connector part for electrically and mechanically connecting the printed circuit board having the land part to the lead part of the electrical component by inserting the lead part into the connector part in the direction which is perpendicular to the surface direction of the printed circuit board.

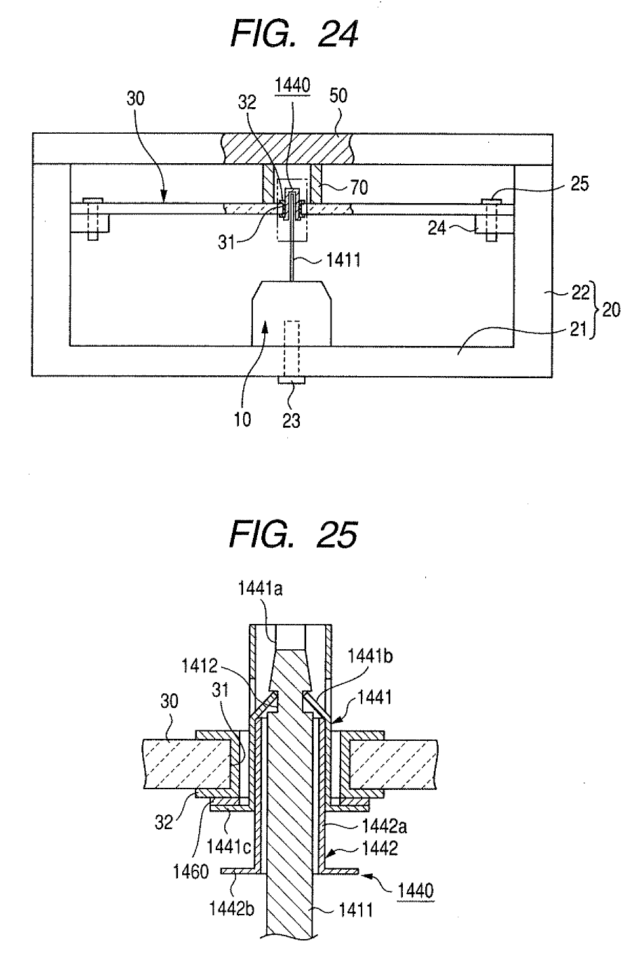

A description will be given of the electrical connector assembly according to the fourteenth embodiment of the present invention with reference to FIG. 24.

FIG. 24 is a view showing a cross section of the electric device 1 having the electrical connector assembly according to the fourteenth embodiment of the present invention. The electrical component 10 and the printed circuit board 30 are electrically and mechanically connected together through connector part 1440 as the electrical connector assembly. FIG. 25 is an enlarged view of the connector part 1440 indicated by a long dashed and double dotted line shown in FIG. 24.

As shown in FIG. 24, the electric device 1 is equipped with the electrical component 10, the case 20, the connector part 1140, and the cap part 50.

The case 20 has the side wall surface part 22 and the bottom surface part 21. The electrical component 10 is placed on the bottom surface part 21 of the case 20. The electrical component 10 is fixed onto the bottom surface part 21 of the case 20 by the screw part 23. The electrical component 10 has a plurality of lead parts 1411. Each of the lead parts 1411 is inserted into the corresponding connector part 1440 in the vertical direction which is perpendicular to the surface direction of the printed circuit board 30. This insertion makes it possible to electrically and mechanically connect the electrical component 10 to the printed circuit board 30 through the connector part 1440. Each of the lead parts 1411 has a convergent shape.

Specifically, as shown in FIG. 25, a groove part 1412 is formed at the front end part of the lead part 1411. The groove part 1412 has a narrow width, when compared with the wide of the lead part in the longitudinal direction thereof, formed at a direction which is perpendicular to the longitudinal direction of the lead part 1411. When the connector part 1440 is engaged with the groove part 1412, the electrical component 10 is electrically and mechanically connected to the printed circuit board 30 through the lead part 1411. The electrical component 10 is a through hole device (THD), for example.

The bottom surface part 21 of the case 20 has a rectangle shape. A side wall surface part 22 stands, namely, is placed in the vertical direction at both sides of the bottom surface part 21. A supporting part 24 is formed at the inside wall surface of the side wall surface part 22. The printed circuit board 30 is mounted to the supporting parts 24 of the case 20 by screw parts 25. As shown in FIG. 2, each of the screw parts 25 fixes the printed circuit board 30 onto the supporting parts 24 of the case 20 by inserting it from the main surface side of the printed circuit board 30 to the supporting parts 24. The printed circuit board 30 is thereby fixed to the case 20.

The printed circuit board 30 is a circuit board which is composed mainly of a printed wiring substrate, on which circuit components and wiring are mounted. A plurality of through holes 31 is formed in the printed circuit board 30, to which the corresponding lead part 1411 is inserted.

Land parts 32 are formed around the through holes 31 on both the front surface (first surface) and the back surface (second surface) of the printed circuit board 30, and further formed on the inside wall surface of the through holes 31.

In the fourteenth embodiment, the through hole 31 has a circular cross section, and formed for each of the lead parts 1411. That is, the total number of the through holes 31 is the equal to that of the lead parts 1411. The land part 32 is formed for each of the through holes 32. The land part 32 is formed on the inside wall surface of the trough hole 31 having a circular cross section and the peripheral area around the through hole 31 on the front surface and the back surface of the printed circuit board 30. The land part 32 is electrically connected to a corresponding circuit wiring formed on the printed circuit board 30.

When the connector part 1440 is electrically connected to the land part 32, the connector part 1140 is electrically connected to the corresponding circuit wiring formed on the printed circuit board 30. The total number of the connector parts 1440 is equal to that of the lead parts 1411. Each of the lead parts 1411 is inserted into the corresponding connector part 1440 in order to electrically and mechanically connected to the corresponding connector part 1440. The connector part 1440 has a detachable structure from the lead part 1411. The lead part 1411 is inserted into the terminal fixing part 43 of the connector part 1440, so that the lead part 1411 is locked by the connector part 1440 and electrically and mechanically connected with the connector part 1440. On the other hand, the lead part 11 and the connector part 1440 are released from the electrical and mechanical connection by unlocking the lead part 1411 from the connector part 1440.

Specifically, as shown in FIG. 15, the connector part 1440 has a locking part 1411 and a lock releasing part 1442.

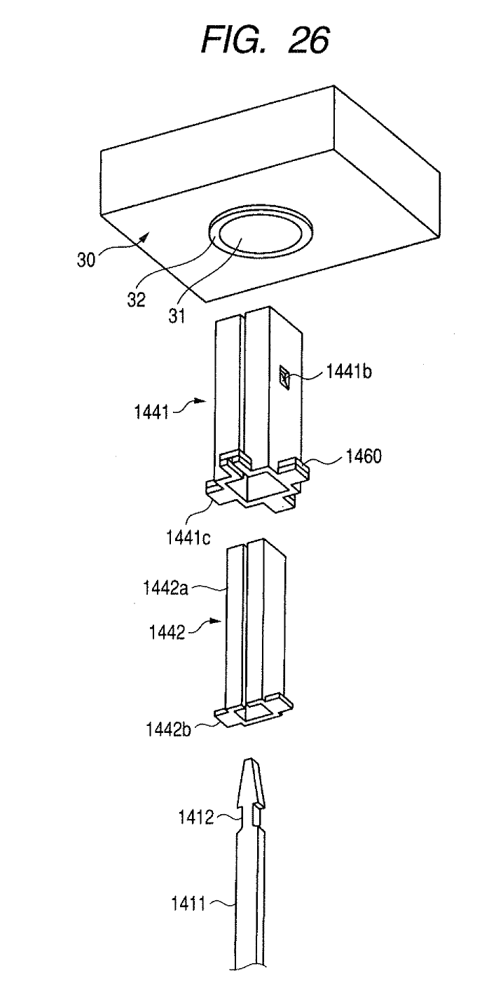

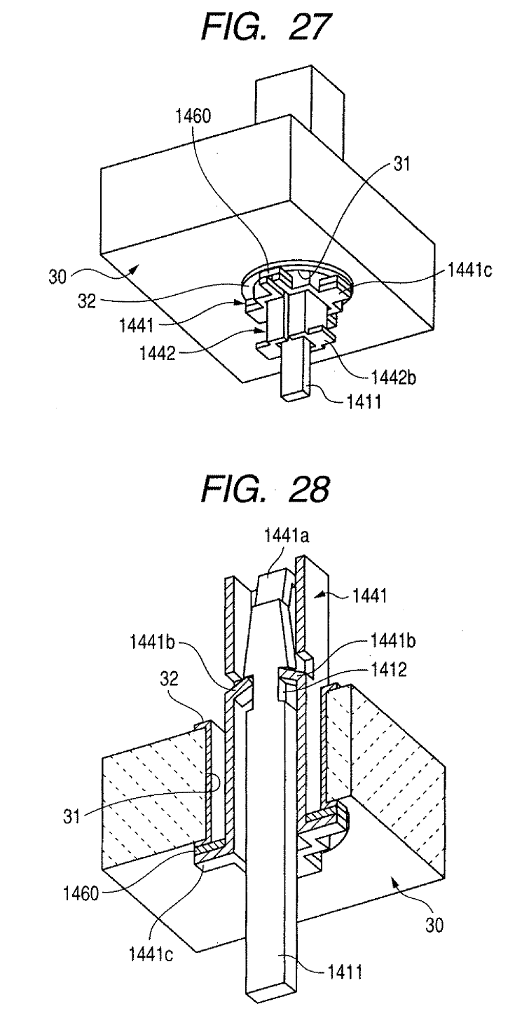

A description will now be given of the structure of the connector part 1440 with reference to FIG. 26, FIG. 27, and FIG. 28.

FIG. 26 is an exploded perspective view of the lead part 1411 and the connector part 1440 which are taken out from the through hole 31 formed in the printed circuit board 30 in the electrical connector assembly shown in FIG. 24. FIG. 27 is a perspective view of the electrical connector assembly shown in FIG. 24 in which the lead part 1411 and the connector part 1440 are inserted in and fitted to the through hole 31. FIG. 28 is view showing a perspective cross section of the electrical connector assembly in which the lead part 1411 is inserted and fitted into the connector part when the locking part 1411 of the connector part 1440 is fitted into the through hole 31 in the electrical connector assembly shown in FIG. 24. The lock releasing part 1442 is not shown in FIG. 28.

As shown in FIG. 26, FIG. 27, and FIG. 28, the locking part 1441 has an approximate rectangle pole shape. For example, the locking part 1441 is made by punching a steel plate in a desired shape, and then bending it.

A front spring part 1441a is formed at a front end part of the locking part 1441, which is made by one surface in four surfaces of a rectangle pole shape so that one surface projects and the projected part is bended.

Holding spring parts 1441b are formed in the two adjacent surfaces which face to each other and are adjacent to the surface which forms the front spring part 1441a. The holding spring parts 1441b are made by punching a central part of each of the two surfaces and bent toward the inside thereof.

The holding spring parts 1441b are tilted from the two adjacent surfaces. The front end part of each of the holding spring parts 1441b is placed toward the front end part of the direction to insert the connector part 1440 toward the through hole 31. The distance between the adjacent holding spring parts 1441b is inserted and fitted to the groove parts 1412 formed in the lead part 1411.

A contact part 1441c is formed at the rear end part of the locking part 1441 in the inserting direction to insert the connector part 1440 into the through hole 31. The contact part 1441c is extended from each of the surfaces of the locking part 1441 having a rectangle pole shape.

The locking part 1441 having the above structure is inserted into the through hole 31 from the front spring part 1441a side so that the contact part 1441c contacts with the land part 32. When the contact part 1441c is fixed to the land part 32 by solder, the locking part 1441 is electrically and mechanically connected to the land part 32.

Because the contact part 1441c is connected to the land part 32 and the contact part 1441c is formed at the rear end part of the locking part 1441 in the direction to insert the locking part 1441 into the through hole 31, it is possible to prevent external force to insert the lead part 1411 into the connector part 1440 from being applied in the direction to separate the contact part 1441c from the land part 32. This can avoid generation of an electrical connection failure between the locking part 1441 and the land part 32.

As shown in FIG. 25 and FIG. 26, the lock releasing part 1442 has an approximate rectangle pole shape having a side wall part 1442a which is extended along the inserting direction to insert the connector part 1440 into the through hole 32. For example, the lock releasing part 1442 is made by punching a steel plate in a desired shape and bending it.

As shown in FIG. 26, an outer dimension (dimension of the outer wall surface) of the lock releasing part 1442 is smaller than the inner dimension (dimension of the inner wall surface) of the locking part 1441, and the inner dimension is larger than the outer dimension of the lead part 1411.

A flange part 1442b is formed at the rear end part of the lock releasing part 1442 in the inserting direction to insert the connector part 1440 into the through hole 31. A side wall surface 1442a of the lock releasing part 1442 is inserted to the inside of the locking part 1441 by using the flange part 1442b.

As shown in FIG. 25, the lock releasing part 1442 having the above structure is fitted to the inside of the locking part 1441. When the lock releasing part 1442 is locked in the locking part 1441, the front end part of the lock releasing part 1442 is positioned at the rear side of the connector part 1440, when observed from the holding spring parts 1441b of the locking part 1441 along the direction to insert the locking part 1441 into the through hole 31.

When the locking of the lead part 1411 is released, the lock releasing part 1442 is pushed toward a deeper region of the locking part 1441 by using the flange part 1442b, and the front end part of the lock releasing part 1442 pushes and spreads out the holding spring parts 1441b, and the holding spring parts 1441b are thereby released from the groove parts 1412 of the lead part 1411.

The cap 60 is placed at the back surface of the printed circuit board 30 in parallel to the printed circuit board 30 in order to cover the printed circuit board 30. For example, the cap 60 is fixed to the case 20 by inserting it under pressure. The buffer member 70 made of elastic member is placed between the cap 60 and the printed circuit board 30. The printed circuit board 30 is pressed toward the bottom surface side 21 of the case 20. This makes it possible for the printed circuit board 30 to be warped and vibrated by thermal expansion, and thereby to suppress the lead part 1411 from sliding relative to the connector part 1440.

A description will now be given of the operation to mount the lead part 1411 of the electrical component 10 to the coil spring 1440 and the operation to detach the lead part 1411 from the coil spring 1440 in the electrical connector assembly for the printed circuit board 30 and the electrical component 10.

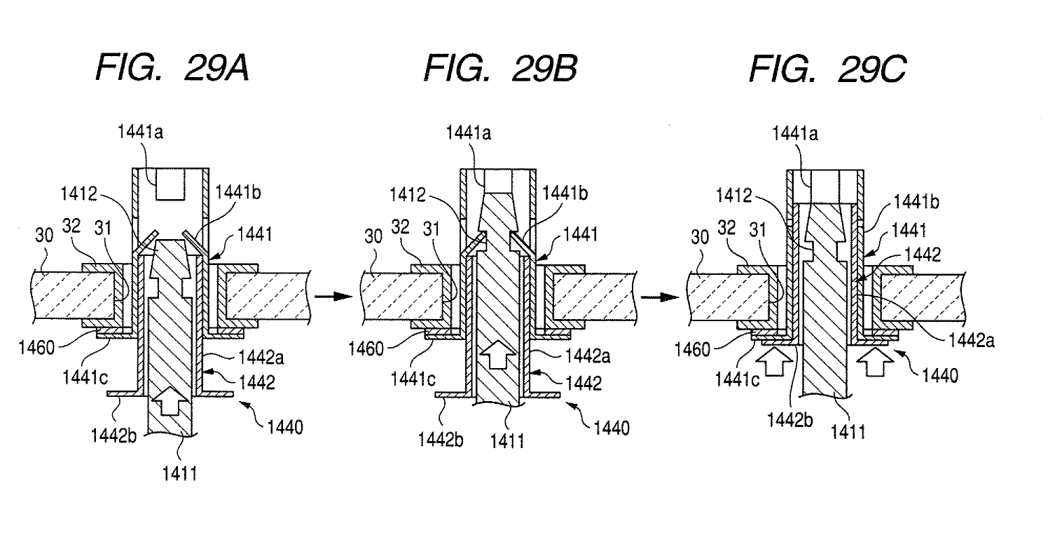

FIG. 29A, FIG. 29B, and FIG. 29C are enlarged views of the lead part 1411 and the connector part 1440 when the lead part 1411 is fitted into and detached from the connector part 1440 in the electrical connector assembly shown in FIG. 24.

As shown in FIG. 29A, before the lead part 1411 is released from the connector part 1440, the connector part 1440 composed of the locking part 1441 and the lock releasing part 1442 forming the connector part 1440 is fitted into the through hole 31, and the contact part 1441c of the locking part 1441 is electrically and mechanically connected to the land part through the plate part 1460. Although the lock releasing part 1442 is fitted into the locking part 1441, the lock releasing part 1442 is slightly pushed into the inside of the locking part 1441 in order to prevent the lock releasing part 1442 from slipping off by a slipping off prevention mechanism (not shown).

The lead part 1411 is inserted and fitted to the connector part 1440 from the direction designated by the arrow shown in FIG. 29A when the lead part 1411 is locked. The front convergent part of the lead part 1411 contacts with the holding spring parts 1441b of the locking part 1441, the locking part 1441 are expanded toward both sides observed from the lead part 1411, and the front end part of the lead part 1411 becomes in contact with the front spring part 1441a of the locking part 1441, and the front spring part 1441a is elastically deformed by the front end part of the lead part 1411.

The lead part 1411 is further fitted toward deeper area of the locking part 1441, as shown in FIG. 29B, the holding spring parts 1441b are fitted to the groove part 1412 formed at the front end part of the lead part 1411. The front end part of the lead part 1411 is thereby fixed by elastic force of the front spring part 1441a and the holding spring parts 1441b. Accordingly, the lead part 1411 is fixed to the connector part 1440, and the electrical component 10 is thereby elastically and mechanically connected to the printed circuit board 30.

On the other hand, when the lead part 1411 is released, namely, unlocked, as shown in FIG. 29B and FIG. 29C, the lock releasing part 1442 is pushed in the inside of the locking part 1441 by pushing the flange part 1342b of the lock releasing part 1442 toward the direction designated by the arrow. The front end part of the lock releasing part 1442 thereby expands the holding spring parts 1441b of the locking part 1441, and the holding spring parts 1441b are released from the groove 1412 of the lead part 1411. This makes it possible to release the front end part of the lead part 1411 from the front spring part 1441a and the holding spring parts 1441b. It is thereby possible to pull the lead part 1411 from the connector part 1440, that is, the lead part 1411 is released from the locked state of the locking part 1441 of the connector part 1440, and the electrical component 10 is electrically and mechanically disconnected from the printed circuit board 30.

As described above, in the electric device 1 equipped with the connector part 1440 as the electric connection assembly of the fourteenth embodiment, the connector part 1440 is composed mainly of the locking part 1441 and the lock releasing part 1442. When the lead part 1411 is locked by the connector part 1440, the front end part of the lead part 1411 is fixed by the front spring part 1441a and the holding spring parts 1441b in the locking part 1441. On the other hand, when the lead part 1411 is released, namely, unlocked from the connector part 1440, the holding spring parts 1441b of the locking part 1441 are pushed and thereby expanded by the lock releasing part 1442. This makes it possible to pull the lead part 1411 from the connector part 1440. Thus, the electrical component 10 can be mounted to and released from the printed circuit board 30 by the electric connector assembly according to the fourteenth embodiment of the present invention.

According to the electric connector assembly having the above structure, it is possible to certainly fix the front end part of the lead part 1411 by the front spring part 1441a and the holding spring parts 1441b of the locking part 1441 when the lead part 1411 is inserted into the connector part 1440. This makes it possible to suppress the lead part 1411 from sliding in the connector part 1440 by thermal expansion. It is therefore possible to suppress a contact point between the lead part 1411 and the connector part 1440 which serve as connector terminals, from sliding together, and prevent the contact resistance between them from increasing.

Further, because the front end part of the holding spring parts 1441b of the locking part 1441 is inserted in the inside of the groove part 1412 of the lead part 1411 in the electric connector assembly according to the fourteenth embodiment, the force to fix the lead part 1411 is supported in the longitudinal direction of the holding spring parts 1441b, namely, in a compressing direction, not in a direction to bend the holding spring parts 1441b. This makes it possible to easily absorb the force acting to deform the front end part of the lead part 1411 caused by external force or thermal expansion. This can suppress the front end part of the lead part 1411 from being separated from the holding spring parts 1441b of the locking part 1441 while the lead part 1411 is locked by the holding spring parts 1441b, and makes it possible to decrease the sliding distance from sliding the lead part 1411 in the connector part 1440.

Still further, the buffer member 70 pushes the printed circuit board 30 toward the bottom surface 21 of the case 20 in the electric connector assembly according to the fourteenth embodiment. This structure makes it possible to suppress the printed circuit board 30 from warping and vibration caused by thermal expansion, and further to suppress the lead part 1411 from sliding in the connector part 1440.

Still further, the electric connector assembly according to the fourteenth embodiment has the structure to fix the lead part 1411 by the connector part 1440, and does not require any additional housing to fix the lead part 1411 to the connector part 1440. This structure can decrease the total number of components of the electric connector assembly.

### Fifteenth Embodiment

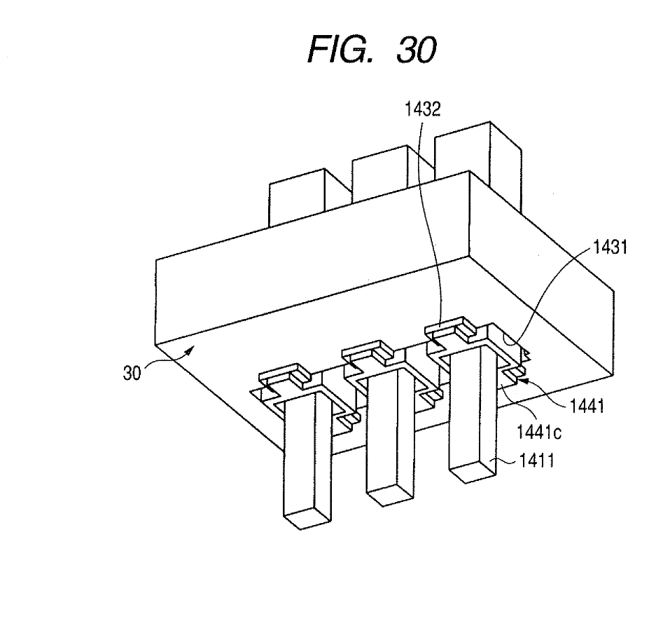

A description will now be given of the electrical connector assembly according to the fifteenth embodiment of the present invention with reference to FIG. 30. The electrical connector assembly used in the electric device 1 according to the fifteenth embodiment has the through hole 1431 and a land part 1432 which are different in structure from them in the electrical connector assembly according to the fourteenth embodiment.

Because other components of the electrical connector assembly according to the fifteenth embodiment have the same structure of those in the electrical connector assembly according to the fourteenth embodiment, the following description will be given of the different components.

FIG. 30 is a perspective view showing the electrical connector assembly in the electric device shown in FIG. 24 according to the fourteenth embodiment of the present invention, in which the lead part and the connector part are fitted into the through hole.

FIG. 30 shows an improved structure in which a plurality of the connector parts 1440 has a common through hole 1431. This structure of the common through hole 1431 allows the size of each of the connector parts 1440 to increase because of not forming a separation wall between adjacent connector parts 1440 when compared with the structure of the fourteenth embodiment to require a separation area which is formed between adjacent connector parts 1440. This makes it possible to easily form each of the connector parts 1440, in particular, to easily bend the front spring part 1441a and the holding spring parts 1441b in the locking part 1441 in order to have a predetermined spring constant.

### (Other Modifications)

In the electrical connector assembly according to the fourteenth and fifteenth embodiment, as previously described, the lead part 1411 has the groove part 1412, which serves as a locking member formed at the front end part of the lead part 1411 in order to fasten the holding spring parts 1441b of the locking part 1441. However, the concept of the present invention is not limited by these embodiments. For example, it is possible for the electric connector assembly to have another structure. That is, because it is sufficient for the locking member (groove part 1412) to have a structure to form the wall surface which is tilted toward the direction to insert the lead part 1411 into the connector part 1440, it is sufficient to form a projecting part at the front end part of the lead part 1411 as the locking part in order to hold the holding spring parts 1441b.

The fourteenth and fifteenth embodiments show the electric device 1 having the electrical connector assembly in which the lead part 1411 is inserted into the connector part 1440 so that the printed circuit board 30 and the electrical component 10 are electrically and mechanically connected together. It is possible to apply the connector part as the electrical connector assembly to various types of electric devices as long as the electric devices can use the electrical connector assembly.

### (Summary of the Fourteenth and Fifteenth Embodiments of the Present Invention)

The present invention provides the electrical connector assembly which comprises a connector part for electrically and mechanically connecting a lead part of an electrical component to a printed circuit board having a through hole and a land part by inserting the lead part into the connector part, where the land part is formed at an opening peripheral part of the through hole, and electrically and mechanically disconnecting the electrical component from the printed circuit board by detaching the lead part from the connector part.

In the electrical connector assembly according to the present invention, the lead part has a locking part formed at a wall surface of a front end part of the lead part in a direction which is perpendicular to the inserting direction to insert the lead part into the connector part, the connector part is composed of a rectangle pole shaped member and fitted to the through hole, and the lead part is inserted and fitted to the connector part,

the connector part comprises a front spring part, a locking part, and a lock releasing part,

the front spring part pushes the front end part of the lead part toward the rear direction which is opposite to the inserting direction to insert the lead part into the connector part,

the locking part comprises holding spring parts which push the front end part of the lead part toward the front spring part side when the holding spring parts lock the locking part,

the lock releasing part is placed in the locking part, composed of a rectangle pole shaped member, and into which the lead part is inserted, and the lock releasing part expands the supporting spring part to release the supporting spring parts from the locking part by the front end part thereof when the lock releasing part is pushed into inside of the locking part.

The above structure of the electric connector assembly makes it possible to certainly fix the front end part of the lead part by the front spring part and the holding spring parts when the lead part is inserted into the connector part. This can suppress the lead part from sliding in the connector part by external force and thermal expansion. It is therefore possible to suppress the contact point between the lead part as the connection terminal and the connector part from sliding, and thereby possible to suppress the contact resistance between them from increasing.

In the electrical connector assembly according to the present invention, the locking part is a groove part having a narrow wide, when compared with a longitudinal wide of the lead part, formed at a direction which is perpendicular to the longitudinal direction of the lead part.

In addition, in the electrical connector assembly according to the present invention, the front spring part 1441a is formed by a projecting part which partially projects from the front end part of the rectangle pole shaped member which forms the locking part and by bending the projecting part.

In the electrical connector assembly according to the present invention, the rectangle pole shaped member, which forms the locking part, has side surface parts which are opposite to each other, and

the holding spring parts are formed by partially bending the side surface parts toward the inside direction of the rectangle pole member.

Accordingly, it is possible to easily form the locking part by punching a single metal plate in a desired shape and then bending the punched metal plate in order to form the front spring part and the holding spring parts.

In the electrical connector assembly according to the present invention, the locking part has a contact part which is formed at the rear end part of the locking part in the inserting direction to insert the connector part into the through hole, and the contact part is extended from each of the side surfaces of the rectangle pole shaped member of the locking part toward the outside direction which is perpendicular to the side surfaces of the rectangle pole shaped member.

As described above, because the contact part is formed at the rear end part of the locking part in the inserting direction to insert the connector part into the through hole and is extended from each of the side surfaces of the rectangle pole shaped member of the locking part toward the outside direction which is perpendicular to the side surfaces of the rectangle pole shaped member, when the contact part of the locking part is fixed to the land part formed in the printed circuit board so as to electrically and mechanically connect between them, it is possible to prevent external force to insert the lead part into the connector part from being applied to the direction to separate the contact part from the land part. This makes it possible to avoid an electrical connection failure between the contact part of the locking part and the land part formed in the printed circuit board.

An electric device according to the present invention comprises a case, an electrical component, the printed circuit board, and the electrical connector assembly. The case part comprises a bottom surface and a side wall which is formed in a direction which is perpendicular to the bottom surface. The electrical component is fixed onto the bottom surface of the case part. The printed circuit board is fixed to the side wall of the case. The electrical connector assembly comprises a connector part for electrically and mechanically connecting the printed circuit board having the land part to the lead part of the electrical component by inserting the lead part into the connector part in the direction which is perpendicular to the surface direction of the printed circuit board.

While specific embodiments of the present invention have been described in detail, it will be appreciated by those skilled in the art that various modifications and alternatives to those details could be developed in light of the overall teachings of the disclosure. Accordingly, the particular arrangements disclosed are meant to be illustrative only and not limited to the scope of the present invention which is to be given the full breadth of the following claims and all equivalents thereof.

What is claimed is:

1. An electrical connector assembly comprising a connector part for electrically and mechanically connecting a printed circuit board having a land part to a lead part of an electrical component by inserting the lead part into the connector part, and electrically and mechanically disconnecting the electrical component from the printed circuit board by detaching the lead part from the connector part, wherein the connector part is made of a line spring member and comprises:
a fixed end part, formed at one end of the line spring member, which is fixed to the land part formed in the printed circuit board;
a terminal fixing part for elastically fasting the lead part of the electrical component, formed by winding the line spring member at the other end of the line spring member which is opposite to the fixed end part in position of the line spring member; and
an elastic deforming part, capable of being elastically deformed, formed between the fixed end part and the terminal fixing part of the line spring member,
wherein the electrical component is mechanically fixed to the printed circuit board and electrically connected to the printed circuit board through the connector part when the lead part of the electrical component is fixed by the terminal fixing part, and
the elastic deforming part is deformed by external force which is applied to the lead part while the terminal fixing part fixes the lead part.

2. The electrical connector assembly according to claim 1, wherein the connector part is a coil spring formed by winding the line spring member so that an inner diameter of the elastic deforming part is greater than an inner diameter of the terminal fixing part, and the coil spring is formed in a longitudinal direction which is perpendicular to a plane direction of the printed circuit board.

3. The electrical connector assembly according to claim 1, wherein the land part is formed on a first surface of the printed circuit board, which faces the electrical component side,
the fixed end part has a concentric circle part placed on the first surface of the printed circuit board which faces the electrical component, and the concentric circle part is fixed to the land part formed on the first surface of the printed circuit board, and
the elastic deforming part is placed on the first surface of the printed circuit board on which the fixed end part having the concentric circle part is placed.

4. The electrical connector assembly according to claim 1, wherein a through hole is formed in the printed circuit board so that the through hole penetrates in a thickness direction of the printed circuit board,
the land part is formed on a first surface of the printed circuit board, which faces the electrical component side and around the through hole,
the fixed end part is wound in a concentric circle on the first surface of the printed circuit board, and the fixed end part has a concentric circle part, and the outermost diameter of the concentric circle part is greater than an inner diameter of the through hole, and the concentric circle part is fixed onto the land part formed on the first surface of the printed circuit board, and
the elastic deforming part projects through the through hole and into a second surface of the printed circuit board which is opposite to the first surface of the printed circuit board.

5. The electrical connector assembly according to claim 1, wherein a through hole is formed in the printed circuit board so that the through hole penetrates in a thickness direction of the printed circuit board,
the land part is formed on a second surface, around the through hole, which is opposite to a first surface of the printed circuit board which faces the electrical component,
the fixed end part is wound in a concentric circle on the second surface of the printed circuit board, and the fixed end part has a concentric circle part, and the outermost diameter of the concentric circle part is greater than an inner diameter of the through hole, and the concentric circle part is fixed onto the land part formed on the second surface of the printed circuit board, and
the elastic deforming part is placed at the second surface side of the printed circuit board which is opposite to the first surface of the printed circuit board.

6. The electrical connector assembly according to claim 1, wherein a through hole is formed in the printed circuit board so that the through hole penetrates in a thickness direction of the printed circuit board,
the land part is formed on a second surface, around the through hole, which is opposite to a first surface of the printed circuit board which faces the electrical component side,
the fixed end part is wound in a concentric circle on the second surface of the printed circuit board, and the fixed end part has a concentric circle part, and the outermost diameter of the concentric circle part is greater than an inner diameter of the through hole, and the concentric circle part is fixed onto the land part formed on the second surface of the printed circuit board, and
the elastic deforming part projects toward the second surface side of the printed circuit board through the through hole.

7. The electrical connector assembly according to claim 5, wherein the fixed end part has the concentric circle part and a vertical part of a compressed shape which is composed of the line spring member spirally wound in a direction which is perpendicular to the surface direction of the printed circuit board, and the fixed end part is fixed onto the land part by solder with which the outer peripheral surface of the vertical part and the concentric circle part are covered to form a solder fillet.

8. The electrical connector assembly according to claim 1, wherein a through hole is formed in the printed circuit board so that the through hole penetrates in a thickness direction of the printed circuit board, the land part is formed on an inner wall surface of the through hole, and the fixed end part is press-inserted into the through hole to fix it to the land part formed on the inner wall surface of the through hole with press-insertion.

9. An electric device comprising:
a case comprising a bottom surface and a side wall which is formed in a direction which is perpendicular to the bottom surface;
an electrical component fixed onto the bottom surface of the case;
a printed circuit board fixed to the side wall of the case; and
the electrical connector assembly according to claim 1 comprising a connector part for electrically and mechanically connecting to the lead part of the electrical component to the printed circuit board with the land part by inserting the lead part of the electrical component into the connector part in the direction which is perpendicular to the surface direction of the printed circuit board.
